(19) United States
(12) Patent Application Publication
(10) Pub. No.: US 2016/0122562 A1
(43) Pub. Date: May 5, 2016

(54) STABLE TRANSPARENT CONDUCTIVE ELEMENTS BASED ON SPARSE METAL CONDUCTIVE LAYERS

(71) Applicants: C3Nano Inc., Hayward, CA (US); Nissha Printing Co., Ltd., Nakagyo-ku (JP)

(72) Inventors: Xiqiang Yang, Hayward, CA (US); Hua Gu, Dublin, CA (US); Yung-Yu Huang, Palo Alto, CA (US); Arthur Yung-Chi Cheng, Fremont, CA (US); Ajay Virkar, San Francisco, CA (US); Ryomei Omote, Yamashina-ku (JP); Kazuhiro Nishikawa, Uji-city (JP); Takeshi Nishimura, Ukyo-ku (JP); Yoshitaka Emoto, Minami-ku (JP)

(21) Appl. No.: 14/527,440

(22) Filed: Oct. 29, 2014

(51) Int. Cl. C09D 7/12; H01B 1/20

(52) U.S. Cl. CPC C09D 7/1241; H01B 1/20

(57) ABSTRACT

Transparent conductive films are described based on sparse metal conductive layers. Stabilization with respect to degradation of electrical conductivity over time is provided for the sparse metal conductive layers through the design of additional layers in the film. Specifically, the sparse metal conductive layer can be placed adjacent coatings with appropriate stabilization compositions as well as through the incorporation into the film of various additional protective layers.

### JOINT DEVELOPMENT AGREEMENT

The inventions described herein are the product of a Joint Development Agreement between C3Nano Inc. and Nissha Printing Co., Limited.

### FIELD OF THE INVENTION

The invention relates to transparent conductive structures that incorporate sparse metal electrically conductive elements, such as nanowires or fused metal nanostructured layers, and to the stabilization of the conductive elements under environmental assaults.

### BACKGROUND OF THE INVENTION

Functional films can provide important roles in a range of contexts. For example, electrically conductive films can be important for the dissipation of static electricity when static can be undesirable or dangerous. Optical films can be used to provide various functions, such as polarization, anti-reflection, phase shifting, brightness enhancement or other functions. High quality displays can comprise one or more optical coatings.

Transparent conductors can be used for several optoelectronic applications including, for example, touch-screens, liquid crystal displays (LCD), flat panel display, organic light emitting diode (OLED), solar cells and smart windows. Historically, indium tin oxide (ITO) has been the material of choice due to its relatively high transparency at high conductivities. There are however several shortcomings with ITO. For example, ITO is a brittle ceramic which needs to be deposited using sputtering, a fabrication process that involves high temperatures and vacuum and therefore can be relatively slow. Additionally, ITO is known to crack easily on flexible substrates.

### SUMMARY OF THE INVENTION

In a first aspect, the invention relates to a transparent electrically conductive film comprising a polymer substrate, a sparse metal conductive layer, and a coating layer. The coating layer can comprise a curable polymer and from about 0.1 wt % to about 8 wt % of a mercaptotriazole, a mercaptotetrazole or a combination thereof and can have an average thickness from about 10 nm to about 2 microns.

In a further aspect, the invention relates to a transparent electrically conductive film comprising a polymer substrate, a conductive layer with a sparse metal conductive layer, a coating layer contacting the conductive layer and comprising a polymer and a stabilization composition, and a multiple layer optically clear adhesive on the coating layer. The multiple layer optically clear adhesive can comprise an adhesive layer and a polyester carrier film between two adhesive layers with an average thickness of the combined adhesive layers and carrier film from about 10 micron to about 300 microns.

In another aspect, the invention relates to a transparent electrically conductive film comprising a polymer substrate, a conductive layer with a nanostructured metal structure and a coating layer contacting the conductive layer and comprising a polymer and a stabilization composition. The coating layer can have a concentration of light stabilization composition from about 0.1 wt % to about 8 wt %. In some embodiments, the sheet resistance of the transparent conductive film increases by no more than about 80% after covering with a black tape and spending 1000 hours in a chamber set at 38° C. at a relative humidity of 50%, a black standard temperature of 60° C. and irradiated with a Xenon lamp through a daylight filter at an intensity of 60 W/m² over the wavelength range from 300 nm to 400 nm.

In additional aspects, the invention relates to a transparent electrically conductive film comprising a polymer substrate, a sparse metal conductive layer, and a coating layer comprising a hindered phenol antioxidant and a hindered amine light stabilization agent.

In other aspects, the invention relates to a transparent electrically conductive film comprising a sparse metal conductive layer with nanostructured metal structure, a polymer substrate and a coating layer, with at least one layer comprising a stabilization composition, wherein the stabilization composition comprises a perfluoroalkylthiol compound, phthalazine or derivatives thereof, a photoacid generator, a polysulfide, or combinations thereof.

### BRIEF DESCRIPTION OF THE DRAWINGS

FIG. 1 is a fragmentary side view of a film with a sparse metal conductive layer and various additional transparent layers on either side of the sparse metal conductive layer.

FIG. 2 is a top view of a representative schematic patterned structure with three electrically conductive pathways formed with sparse metal conductive layers.

FIG. 3 is a schematic diagram showing a capacitance based touch sensor.

FIG. 4 is a schematic diagram showing a resistance based touch sensor.

FIG. 5 is a plot of change in sheet resistance as a function of time of exposure to test conditions for an embodiment with an ST-1 stabilizer in an overcoat layer along with a control plot without the stabilizer.

FIG. 6 is a plot of change in sheet resistance as a function of time of exposure to test conditions for an embodiment with an ST-8 stabilizer in an overcoat layer along with a control plot without the stabilizer.

FIG. 7 is a plot of change in sheet resistance as a function of time of exposure to test conditions for an embodiment with an ST-1 stabilizer in an overcoat layer at two different concentrations along with a control plot without the stabilizer.

FIG. 8 is a plot of change in sheet resistance as a function of time of exposure to test conditions for four samples representing two different overcoat compositions with two different optically clear adhesives.

FIG. 9 is a plot of change in sheet resistance as a function of time of exposure to test conditions for four samples, in which two samples had commercial barrier films and the other two had hard coated PET films of different thicknesses.

FIG. 10 is a plot of change in sheet resistance as a function of time of exposure to test conditions for two samples having an overcoat with ST-1 stabilizer, an optically clear adhesive and either a hard coated PET cover or a commercial barrier film cover.

FIG. 11 is a plot of change in sheet resistance as a function of time of exposure to test conditions for samples covered with tape, half covered with tape or uncovered with tape.

FIG. 12 is a plot of change in sheet resistance as a function of time of exposure to test conditions for samples covered with tape, half covered with tape or uncovered with tape, in which the samples all have an overcoat with ST-1 stabilizer.

FIG. 13 is a plot of change in sheet resistance as a function of time of exposure to test conditions for samples covered with tape, half covered with tape or uncovered with tape, in which the samples all have an overcoat with ST-9 stabilizer.

FIG. 14 is a plot of change in sheet resistance as a function of time of exposure to test conditions for samples that have an uncovered overcoat layer with stabilization compounds, ST-5, ST-1 and ST-15, or ST-1 and ST-16.

FIG. 15 is a plot of change in sheet resistance as a function of time of exposure to test conditions for samples having no stabilizer in the overcoat, ST-1, ST-13, ST-1 and ST-13, or ST-13 and ST-14 stabilizers.

FIG. 16 is a plot of change in sheet resistance as a function of time of exposure to test conditions for samples formed with a roll-to-roll processor.

FIG. 17 is an exploded schematic view of a transparent conductive film configured for testing in a second set of tests for environmental exposure.

FIG. 18 is a top view of the transparent conductive film of FIG. 17 with 6 measurement points noted.

FIG. 19 is a group of plots for three sets of samples of change in sheet resistance as a function of time of exposure to test conditions with measurement plotted for the 6 locations noted in FIG. 18.

FIG. 20 is a group of plots for three alternative sets of samples of change in sheet resistance as a function of time of exposure to test conditions with measurement plotted for the 6 locations noted in FIG. 18, in which a different overcoat was used relative to obtain the results in FIG. 19 and noted barrier films were tested.

FIG. 21 is a group of plots for three alternative sets of samples of change in sheet resistance as a function of time of exposure to test conditions with measurement plotted for the 6 locations noted in FIG. 18, in which a third different overcoat was used relative to obtain the results in FIG. 19 and noted barrier films were tested.

FIG. 22 is a group of three plots for three alternative sets of samples change in sheet resistance over a half an hour exposed to higher temperature conditions.

### DETAILED DESCRIPTION

Transparent electrically conductive films incorporate features to stabilize sparse metal conductive layers to preserve desirable levels of electrical conductivity when subjected to the ambient environment, light, heat and other environmental assaults associated with use of the device. Sparse metal conductive layers can comprise metal nanowires or fused metal nanostructured networks that are formed from nanowires. As described below, fused metal nanostructured networks formed from metal nanowires offer desirable properties with respect to electrical conductivity, optical properties and convenient processing. Stabilization can comprise the inclusion of a stabilization composition in a coating layer adjacent the sparse metal conductive layer. Alternatively or additionally, the selection of other structural elements, such as an appropriately selected optically clear adhesive layer, can further contribute significantly to stabilization of the electrical conduction properties. The stabilization of the sparse metal conductive layer provides desirable features that provide suitable properties for a range of commercial applications, such as touch sensors.

Transparent electrically conductive elements, e.g., films, of particular interest herein comprise a sparse metal conductive layer. The conductive layers are generally sparse to provide desired amount of optical transparency, so the coverage of the metal has very significant gaps over the layer of the conductive element. For example, transparent electrically conductive films can comprise metal nanowires deposited along a layer where sufficient contact can be provided for electron percolation to provide suitable conduction pathways. In other embodiments, the transparent electrically conductive film can comprise a fused metal nanostructured network, which has been found to exhibit desirable electrical and optical properties. Conductivity referenced herein refers to electrical conductivity unless specifically indicated otherwise.

Sparse metal conductive layers, regardless of the specific structures, are vulnerable to environmental assaults. The sparse feature implies that the structures are somewhat fragile. Assuming that the elements are appropriately protected from mechanical damage, the sparse metal conductive layers can be vulnerable to damage from various other sources, such as atmospheric oxygen, water vapor, other corrosive chemicals in the local environment, light, heat, combinations thereof, and the like. For commercial applications, degradation of properties of the transparent conductive structures should be within desired specifications, which in other words indicates that the transparent conductive layers provide suitable lifetimes for devices incorporating them. To achieve these objectives, stabilization approaches have been found and these are described herein. Accelerated wear studies are described to test the transparent conductive films.

It has been found that very effective stabilization of the sparse metal conductive layer can be achieved through the appropriate design of the overall structure. In particular, a stabilization composition can be placed in a layer adjacent the sparse metal conductive element, which can be an overcoat layer or an undercoat layer. Desirable stabilization compounds are discussed in detail below. To simplify the discussion, a reference to a coating layer refers to an overcoat layer, an undercoat layer or both unless explicitly stated otherwise. Furthermore, an optically clear adhesive, e.g. as a component of the film, can be used to provide for attaching the transparent conductive film to a device, and the selection of the optically clear adhesive has been found to significantly facilitate obtaining a desired degree of stabilization. In particular, optically clear adhesives can comprise a double sided adhesive layers on a carrier layer. The carrier layer can be a polyester, such as PET or a commercial barrier layer material, which may provide a desirable moisture and gas barrier to protect the sparse metal conductive layers, although Applicant does not want to be limited by a theory of operation of particular optically clear adhesives.

The stabilization of silver nanowire conductive layers is also described, for example, in published U.S. patent applications 2014/0234661 to Allemand et al. (the '661 application), entitled “Methods to Incorporate Silver Nanowire-Based Transparent Conductors in Electronic Devices,” 2014/0170407 to Zou et al. (the '407 application), entitled “Anticorrosion Agents for Transparent Conductive Film,” and 2014/0205845 to Philip, Jr. et al. (the '845 application), entitled “Stabilization Agents for Transparent Conductive Films,” all three of which are incorporated herein by reference. Applicant has discovered a particular combination of stabilization features provides excellent stabilization with commercially reasonable structures. In particular, relatively low concentrations of a stabilization compound in a coating layer optionally combined with an appropriately selected optically clear adhesive can greatly improve the stability of the sparse nanostructured metal element.

In general, various sparse metal conductive layers can be formed from metal nanowires. Films formed with metal nanowires that are processed to flatten the nanowires at junctions to improve conductivity is described in U.S. Pat. No. 8,049,333 to Alden et al., entitled “Transparent Conductors Comprising Metal Nanowires,” incorporated herein by references. Structures comprising surface embedded metal nanowires to increase metal conductivity are described in U.S. Pat. No. 8,748,749 to Srinivas et al., entitled “Patterned Transparent Conductors and Related Manufacturing Methods,” incorporated herein by reference. However, desirable properties have been found for fused metal nanostructured networks with respect to high electrical conductivity and desirable optical properties with respect to transparency and low haze. Fusing of adjacent metal nanowires can be performed based on chemical processes under commercially appropriate processing conditions.

Metal nanowires can be formed from a range of metals, and metal nanowires are available commercially. While metal nanowires are inherently electrically conducting, the vast majority of resistance in the metal nanowires based films is believed to due to the junctions between nanowires. Depending on processing conditions and nanowire properties, the sheet resistance of a relatively transparent nanowire film, as deposited, can be very large, such as in the giga-ohm/sq range or even higher. Various approaches have been proposed to reduce the electrical resistance of the nanowire films without destroying the optical transparency. Low temperature chemical fusing to form a metal nanostructured network has been found to be very effective at lowering the electrical resistance while maintaining the optical transparency.

In particular, a significant advance with respect to achieving electrically conductive films based on metal nanowires has been the discovery of well controllable processes to form a fused metal network where adjacent sections of the metal nanowires fuse. Fusing of metal nanowires with various fusing sources is described further in published U.S. patent applications 2013/0341074 to Virkar et al., entitled “Metal Nanowire Networks and Transparent Conductive Material,” and 2013/0342221 to Virkar et al. (the '221 application), entitled “Metal Nanostructured Networks and Transparent Conductive Material,” 2014/0238833 to Virkar et al. (the '833 application), entitled “Fused Metal Nanostructured Networks, Fusing Solutions With Reducing Agents and Methods for Forming Metal Networks,” and copending U.S. patent application Ser. No. 14/087,669 to Yang et al. (the '669 application), entitled “Transparent Conductive Coatings Based on Metal Nanowires, Solution Processing Thereof, and Patterning Approaches,” copending U.S. patent application Ser. No. 14/448,504 to Li et al, entitled “Metal Nanowire Inks for the Formation of Transparent Conductive Films With Fused Networks,” all of which are incorporated herein by reference.

The transparent conductive films generally comprise several components or layers that contribute to the processability and/or the mechanical properties of the structure without detrimentally altering the optical properties. In some embodiments, the stabilization compounds can be added in low amounts and are not observed to alter the optical properties of the structure by more than 10% with respect to haze and/or absorption, i.e., decrease in transmission, if at all. The sparse metal conductive layers can be designed to have desirable optical properties when incorporated into the transparent conductive films. The sparse metal conductive layer may or may not further comprise a polymer binder. Unless otherwise indicated, references to thicknesses refer to average thicknesses over the referenced layer or film, and adjacent layers may intertwine at their boundaries depending on the particular materials. In some embodiments, the total film structure can have a total transmission of visible light of at least about 85%, a haze of no more than about 2 percent and a sheet resistance after formation of no more than about 250 ohm/sq.

In the context of the current work, instability seems associated with a restructuring of the metal in the conductive element that results in a lowering of electrical conductivity, which can be measured as an increase in sheet resistance. Thus, the stability can be evaluated in terms of the amount of an increase in sheet resistance over time. A particular accelerated test apparatus and conditions in the apparatus are described in detail below. The test apparatus provides an intense light source, heat and humidity in a controlled environment. Under the relatively stringent conditions of the test, the transparent conductive elements have exhibit an increase in sheet resistance of no more than about 30% in 600 hours and an increase of no more than about 75% in 2000 hours.

It has been found that particular instabilities occur at portions of a film that is covered, which can correspond to an edge of a transparent conductive film of an actual device where electrical connections to the transparent conductive film are made and hidden from view. The covered portions of the transparent conductive film are heated when the covered film is subjected to lighted conditions, and the heat is believed to contribute to instabilities that are addressed herein. Some testing is performed using covered and partially covered transparent conductive films to apply more stringent testing conditions.

Transparent, electrically conductive films find important applications, for example in solar cells and touch screens. Transparent conductive films formed from metal nanowire components offer the promise of lower cost processing and more adaptable physical properties relative to traditional materials. In a multilayered film with various structural polymer layer(s), the resulting film structure has been found to be robust with respect to processing while maintaining desirable electrical conductivity, and the incorporation of desirable components as described herein can additionally provide stabilization without degrading the functional properties of the film so that devices incorporating the films can have suitable lifetimes in normal use.

### Transparent Conductive Films

The transparent electrically conductive structures or films generally comprise a sparse metal conductive layer that provides the electrical conductivity without significantly adversely altering the optical properties and various additional layers that provide mechanical support as well as protection of the conductive element. The sparse metal conductive layer is extremely thin and correspondingly susceptible to damage by mechanical and other abuses. With respect to sensitivities to environmental damage, it has been found that an undercoat and/or overcoat can comprise a stabilization composition that can provide desirable protection, and certain classes of optically clear adhesives and/or barrier layers can also provide valuable protection from light, heat, chemicals and other environmental damage. While the focus herein is on environmental assaults from humid air, heat and light, polymer sheets used to protect the conductive layers from these environmental assaults can also provide protection from contact and the like.

Thus, the sparse metal conductive layer can be formed on a substrate that can have one or more layers in the structure of the substrate. The substrate generally can be identified as a self supporting film or sheet structure. A thin solution processed layer, referred to as an undercoat, can be optionally placed along the top surface of the substrate film and immediately under the sparse metal conductive layer. Also, the sparse metal conductive can be coated with additional layers that provide some protection on the side of the sparse metal conductive layer opposite the substrate. In general, the electrically conductive structure can be placed in either orientation in the final product, i.e., with the substrate facing outward to the substrate against the surface of the product supporting the electrically conductive structure.

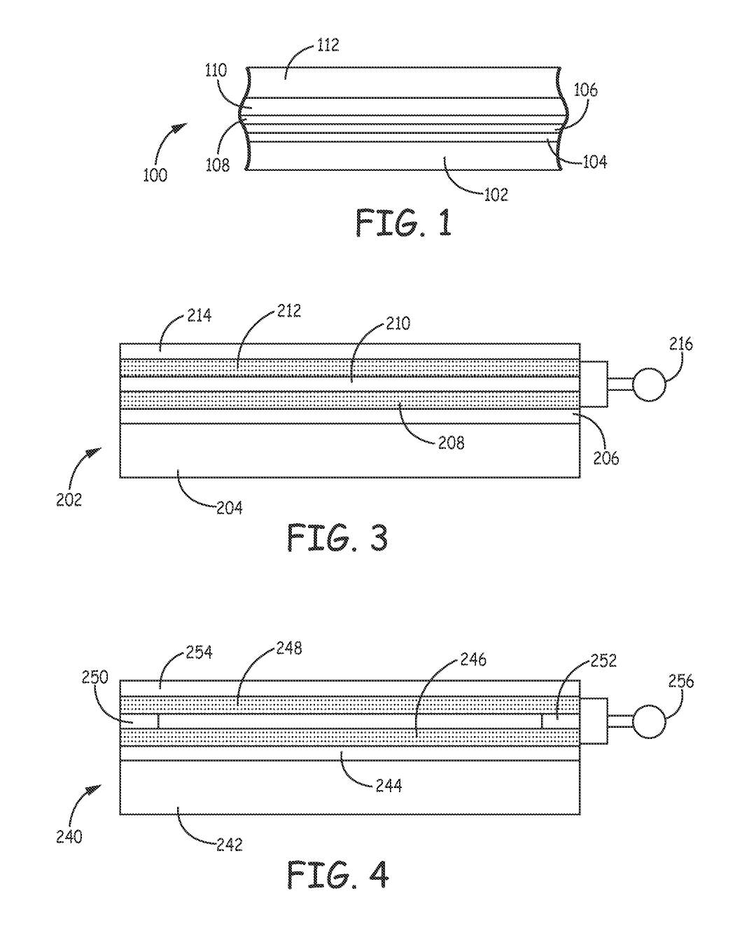

Referring to FIG. 1, representative transparent conductive film 100 comprises a substrate 102, undercoat layer 104, sparse metal conductive layer 106, overcoat layer 108, optically clear adhesive layer 110 and protective surface layer 112, although not all embodiments include all layers. A transparent conductive film generally comprises a sparse metal conductive layer and at least one layer on each side of the sparse metal conductive layer. The total thickness of the transparent conductive film can generally have a thickness from 10 microns to about 3 millimeters (mm), in further embodiments from about 15 microns to about 2.5 mm and in other embodiments from about 25 microns to about 1.5 mm. A person of ordinary skill in the art will recognize that additional ranges of thicknesses within the explicit ranges above are contemplated and are within the present disclosure. In some embodiments, the length and width of the film as produced can be selected to be appropriate for a specific application so that the film can be directly introduced for further processing into a product. In additional or alternative embodiments, a width of the film can be selected for a specific application, while the length of the film can be long with the expectation that the film can be cut to a desired length for use. For example, the film can be in long sheets or a roll. Similarly, in some embodiments, the film can be on a roll or in another large standard format and elements of the film can be cut according to a desired length and width for use.

Substrate 102 generally comprises a durable support layer formed from an appropriate polymer or polymers. In some embodiments, the substrate can has a thickness from about 20 microns to about 1.5 mm, in further embodiments from about 35 microns to about 1.25 mm and in additional embodiments from about 50 microns to about 1 mm. A person of ordinary skill in the art will recognize that additional ranges of thicknesses of the substrate within the explicit ranges above are contemplated and are within the present disclosure. Suitable optically clear polymers with very good transparency, low haze and good protective abilities can be used for the substrate. Suitable polymers include, for example, polyethylene terephthalate (PET), polyethylene naphthalate (PEN), polyacrylate, poly(methyl methacrylate), polyolefin, polyvinyl chloride, fluoropolymers, polyamide, polyimide, polysulfone, polysiloxane, polyetheretherketone, polynorbornene, polyester, polystyrene, polyurethane, polyvinyl alcohol, polyvinyl acetate, acrylonitrile-butadiene-styrene copolymer, cyclic olefin polymer, cyclic olefin copolymer, polycarbonate, copolymers thereof or blend thereof or the like. Suitable commercial polycarbonate substrates include, for example, MAKROFOL SR243 1-1 CG, commercially available from Bayer Material Science; TAP® Plastic, commercially available from TAP Plastics; and LEXAN™ 8010CDE, commercially available from SABIC Innovative Plastics. Protective surface layer 112 can independently have a thickness and composition covering the same thickness ranges and composition ranges as the substrate as described in this paragraph above.

Optional undercoat 104 and/or optional overcoat 108, independently selectable for inclusion, can be placed respectively under or over sparse metal conductive layer 106. Optional coatings 104, 108 can comprise a curable polymer, e.g., heat curable or radiation curable polymers. Suitable polymers for coatings 104, 106 are described below as binders for inclusion in the metal nanowire inks, and the list of polymers, corresponding cross linking agents and additives apply equally to optional coatings 104, 108 without repeating the discussion explicitly here. Coatings 104, 108 can have a thickness from about 25 nm to about 2 microns, in further embodiments from about 40 nm to about 1.5 microns and in additional embodiments from about 50 nm to about 1 micron. A person of ordinary skill in the art will recognize that additional ranges of overcoat thickness within the explicit ranges above are contemplated and are within the present disclosure. Optional optically clear adhesive layer 110 can have a thickness from about 10 microns to about 300 microns, in further embodiments from about 15 microns to about 250 microns and in other embodiments from about 20 microns to about 200 microns. A person of ordinary skill in the art will recognize that additional ranges of thicknesses of optically clear adhesive layers within the explicit ranges above are contemplated and are within the present disclosure. Suitable optically clear adhesives can be contact adhesives. Optically clear adhesives include, for example, coatable compositions and adhesive tapes. UV curable liquid optically clear adhesives are available based on acrylic or polysiloxane chemistries. Suitable adhesive tapes are available commercially, for example, from Lintec Corporation (MO series); Saint Gobain Performance Plastics (DF713 series); Nitto Americas (Nitto Denko) (LUCIACS CS9621T and LUCIAS CS9622T); DIC Corporation (DAITAC LT series OCA, DAITAC WS series OCA and DAITAC ZB series); PANAC Plastic Film Company (PANACLEAN series); Minnesota Mining and Manufacturing (3M, Minnesota U.S.A.—product numbers 8146, 8171, 8172, 8173 and similar products) and Adhesive Research (for example product 8932).

Some optically clear adhesive tapes comprise a carrier film, such as a polyethylene terephthalate (PET). It has been discovered that the presence of a carrier film can improve the stabilizing properties of an optically clear adhesive tape relative to corresponding films with optically clear adhesive tapes without carrier films. While not wanting to be limited by theory, this improvement may be due to decreased water and oxygen permeability through the carrier film. Optically clear adhesive tapes can be double sticky tapes with a carrier film between two adhesive layers, see for example 3M 8173KCL. Of course, such a double sticky structure can be created using a two adhesive tape layers with a polymer film, such as a protective film 112, sandwiched between them, and presumably the effectiveness would be comparable if reproduced during production. The carrier film for the adhesive according the present invention can be normal PET thin films like that in 3M 8173KCL. More broadly other polymer films with acceptable optical and mechanical properties can also be used, such as polypropylene (PP), polycarbonate (PC), cyclic olefin polymer (COP), cyclic olefin copolymer (COC), and the like. In all cases, the carrier film needs to have good adhesion with the adhesive composition and provide mechanical stiffness for easier handling.

The amount of nanowires delivered onto the substrate for sparse metal conductive layer 106 can involve a balance of factors to achieve desired amounts of transparency and electrical conductivity. While thickness of the nanowire network can in principle be evaluated using scanning electron microscopy, the network can be relatively sparse to provide for optical transparency, which can complicate the measurement. In general, the sparse metal conductive structure, e.g., fused metal nanowire network, would have an average thickness of no more than about 5 microns, in further embodiments no more than about 2 microns and in other embodiments from about 10 nm to about 500 nm. However, the sparse metal conductive structures are generally relatively open structures with significant surface texture on a submicron scale. The loading levels of the nanowires can provide a useful parameter of the network that can be readily evaluated, and the loading value provides an alternative parameter related to thickness. Thus, as used herein, loading levels of nanowires onto the substrate is generally presented as milligrams of nanowires for a square meter of substrate. In general, the nanowire networks can have a loading from about 0.1 milligrams (mg)/m² to about 300 mg/m², in further embodiments from about 0.5 mg/m² to about 200 mg/m², and in other embodiments from about 1 mg/m² to about 150 mg/m². A person of ordinary skill in the art will recognize that additional ranges of thickness and loading within the explicit ranges above are contemplated and are within the present disclosure. If the sparse metal conductive layer is patterned, the thickness and loading discussion applies only to the regions where metal is not excluded or significantly diminished by the patterning process.

Generally, within the total thicknesses above for particular components of film 100, layers 102, 104, 106, 108, 110 can be subdivided into sub-layers, for example, with different compositions from other sub-layers. For example, multiple layer optically clear adhesives are discussed above. Thus, more complex layer stacks can be formed. Sub-layers may or may not be processed similarly to other sub-layers within a particular layer, for example, one sub-layer can be laminated while another sub-layer can be coated and cured.

Stabilization compositions can be placed in appropriate layers to stabilize the sparse metal conductive layers. For embodiments in which the sparse metal conductive layers comprise fused nanostructured metal networks, the sparse metal conductive layer itself as formed may not comprise a stabilization compound since the presence of such compounds can inhibit the chemical fusing process. In alternative embodiments, it may be acceptable to include the stabilization agents in coating solutions for forming the sparse metal conductive layer. Similarly, stabilization compounds can be included in an optically clear adhesive composition. However, it has been found that the stabilization compounds can be included effectively in a coating layer, which can correspondingly be made relatively thin while still providing effective stabilization.

A coating layer can comprise a stabilization compound in a concentration from about 0.1 weight percent (wt %) to about 8 wt %, in further embodiments from about 0.25 wt % to about 6 wt % and in additional embodiments from about 0.5 wt % to about 4 wt %. As shown in the Examples below, it has been found that increases in stabilization compound concentrations do not necessarily result in improved stabilization. In addition, it has been found that thin coating layers can effectively provide stabilization, which implies that the layers do not function as a reservoir of stabilization compounds since a great volume of stabilization compound does not seem correlated with stabilization. Thus, it has been found that desirable stabilization can be obtained with low totals of stabilization agents, which can be desirable form a processing perspective as well as having a low effect on the optical properties.

For some applications, it is desirable to pattern the electrically conductive portions of the film to introduce desired functionality, such as distinct regions of a touch sensor. Patterning can be performed by changing the metal loading on the substrate surface either by printing metal nanowires at selected locations with other locations being effectively barren of metal or to etch or otherwise ablate metal from selected locations either before and/or after fusing the nanowires. However, it has been discovered that high contrast in electrical conductivity can be achieved between fused and unfused portions of a layer with essentially equivalent metal loading so that patterning can be performed by selectively fusing the metal nanowires. This ability to pattern based on fusing provides significant additional patterning options based on selective fusing of the nanowires, for example, through the selective delivery of a fusing solution or vapor. Patterning based on selective fusing of metal nanowires is described in the '833 application and the '669 application above.

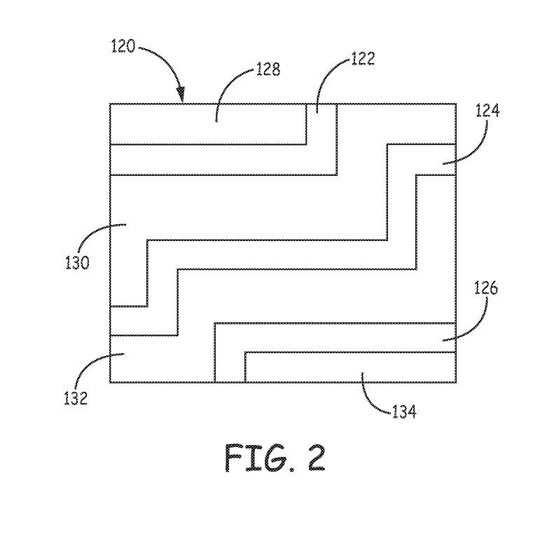

As a schematic example, a fused metal nanostructured network can form conductive patterns along a substrate surface 120 with a plurality of electrically conductive pathways 122, 124, and 126 surrounded by electrically resistive regions 128, 130, 132, 134, as shown in FIG. 2. As shown in FIG. 2, the fused area correspond with three distinct electrically conductive regions corresponding with electrically conductive pathways 122, 124, and 126. Although three independently connected conductive regions have been illustrated in FIG. 2, it is understood that patterns with two, four or more than 4 conductive independent conductive pathways or regions can be formed as desired. For many commercial applications, fairly intricate patterns can be formed with a large number of elements. In particular, with available patterning technology adapted for the patterning of the films described herein, very fine patterns can be formed with highly resolved features. Similarly, the shapes of the particular conductive regions can be selected as desired.

The transparent conductive film is generally built up around the sparse metal conductive element which is deposited to form the functional feature of the film. Various layers are coated, laminated or otherwise added to the structure using appropriate film processing approaches. As described herein, the nature of the layers can significant can alter the long term performance of the transparent conductive film. The deposit of the sparse metal conductive layer is described further below in the context of a fused metal nanostructured layers, but un-fused metal nanowire coatings can be similarly deposited except that the fusing components are absent.

The sparse metal conductive layer generally is solution coated onto a substrate, which may or may not have a coating layer on top of the substrate that then forms an undercoat adjacent the sparse metal conductive layer. An overcoat can be solution coated onto the sparse metal conductive layer in some embodiments. Crosslinking, with application of UV light, heat or other radiation, can be performed to crosslink polymer binders in the coating layers and/or the sparse metal conductive layer, which can be performed in one step or multiple steps. A stabilization compound can be incorporated into the coating solution for forming a coating layer. The coating precursor solution can comprise 0.001 weight percent (wt %) to about 0.1 wt % stabilization compound, in further embodiments from about 0.002 wt % to about 0.05 wt %, in additional embodiments from about 0.003 wt % to about 0.04 wt % and in other embodiments from about 0.003 wt % to about 0.025 wt % stabilization compound. A person of ordinary skill in the art will recognize that additional ranges of stabilization compound in a coating solution within the explicit ranges above are contemplated and are within the present disclosure.

An optically clear adhesive layer can be laminated or otherwise applied to the sparse metal conductive layer with or without an overcoat layer(s) that becomes located adjacent the optically clear adhesive. A stabilization composition can be associated with an optically clear adhesive through the contact of a solution comprising the stabilization compound with the optically clear adhesive, such as by spraying or dipping a solution of the stabilization compound with the optically clear adhesive. Alternatively or additionally, the stabilization compound can be incorporated into the adhesive composition during the manufacture of the adhesive. In some embodiments, an additional protective film can be applied over the optically clear adhesive layer, or a protective polymer film can be laminated or otherwise applied to an overcoat or directly to the sparse metal conductive layer without an intervening optically conductive adhesive.

A protective film can be placed over the optically clear adhesive to form a further protective layer. Suitable protective films can be formed of similar materials as described for the substrate material, or specific commercial barrier films can be used. For example, the protective films can be formed from polyester sheets with coatings. Hard coated polyester sheets are commercially available, in which the hard coats are crosslinked acrylic polymers or other crosslinked polymers. Hard coated polyester sheets are desirable due to a relatively low cost and desirable optical properties, such as a high transparency and low haze. Thicker hard coated polyester films can be used to increase their barrier function, such as sheets having a thickness from about 15 microns to about 200 microns and in further embodiments from about 20 microns to about 150 microns. A person of ordinary skill in the art will recognize that additional ranges of hard coated polyester films are contemplated and are within the present disclosure.

While the mechanisms of temporal degradation of the electrically conductive ability of the sparse metal conductive layers is not completely understood, it is believed that molecular oxygen (O₂) and/or water vapor may play a role. From this perspective, barrier films to oxygen and/or water vapor would be desirable, and physical barrier tend to block migration of environmental contaminants generally. The '661 application describes commercial oxygen barrier films with inorganic coatings on PET substrates and asserted improvement in stability based on these barrier films. In the Examples below, a commercial barrier film that provides a barrier to both water and molecular oxygen with very good optical properties. Desirable barrier films can provide good optical properties. The barrier films generally can have a thickness ranging from about 10 microns to about 300 microns, in further embodiments from about 15 microns to about 250 microns and in other embodiments from about 20 microns to about 200 microns. In some embodiments, the barrier films can have a water vapor permeability of no more than about 0.15 g/(m²·day), in further embodiments no more than about 0.1 g/(m²·day) and in additional embodiments no more than about 0.06 g/(m²·day). Furthermore, the barrier films can have an optical total transmittance of visible light of at least about 86%, in further embodiments at least about 88% and in other embodiments at least about 90.5%. A person of ordinary skill in the art will recognize that additional ranges of thickness, total transmittance and water vapor permeability within the explicit ranges above are contemplated and are within the present disclosure.

In some embodiments, good stability results have been obtained with basic protective polymer films that are not formally sold as barrier films. Thus, clear protective polymer films can be used formed from, for example, polyethylene terephthalate (PET), hard coated PET (HC-PET) that can have a hard coat on one or both sides, polycarbonate, cyclic olefin polymer, cyclic olefin copolymers, or combinations thereof. Generally, suitable protective polymer films can have the same thicknesses as described immediately above for the barrier films, and generally barrier films may have a supportive core of similar polymers, such as PET, in combination with ceramic, metallic, or other materials contributing to the barrier function. While the basic protective polymer films may not provide equivalent reduction in water vapor or molecular oxygen migration, these films can provide suitable stabilization at a modest cost especially when used in combination with an optically clear adhesive with a carrier film.

The results presented herein indicate that a combination of stabilization features can effectively provide a high degree of stabilization as determined with selected accelerated age testing. Specifically, the inclusion of appropriate stabilization compositions in a coat layer can be combined with an optically clear adhesive with a polyester carrier film and/or a protective cover film to stabilize the sparse metal conductive layer and maintain a desirably low sheet resistance.

Optically clear adhesive layers and thicker protective films covering the sparse metal conductive layer can be formed with holes or the like in appropriate locations to provide for electrical connections to the conductive layer. In general, various polymer film processing techniques and equipment can be used to the processing of these polymer sheets, and such equipment and techniques are well developed in the art, and future developed processing techniques and equipment can be correspondingly adapted for the materials herein.

### Stabilization Compositions

Various stabilization compounds can be incorporated into the transparent conductive films to improve the stability of the sparse metal conductive element. As noted above, stabilization of sparse metal conductive layers can involve several aspects, such as barrier layers and the like. The stabilization compositions discussed presently involve compounds that are generally placed in coating layers immediately adjacent the sparse metal conductive layers, although the stabilization compounds may be effective with placement into other layers of the film. It is not known if the stabilization compounds migrate or do not migrate into specific contact with the metal in the conductive layer, but the stabilization compositions evidently influence the local chemical environment since the compositions are effective in low amounts in the specific vicinity of the conductive layer since a coating layer can be very thin, e.g., no more than a micron in average thickness, yet effective.

A first class of stabilization compounds comprises mercaptotetrazoles or mercaptotriazoles. As suggested in the '407 application cited above, these compounds have been proposed as introducing anticorrosion properties in silver nanowire films. The '661 application cited above recites tetrazole compounds and triazole compounds as photo-desensitizing compounds that provide photo-stability. The mercaptotetrazole compounds can be represented by the following general formula:

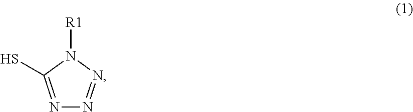

where R1 is hydrogen, a substituted or unsubstituted alkyl group comprising from 1 to 20 carbon atoms, a substituted or unsubstituted aryl group with up to 10 carbon atoms, a substituted or unsubstituted alkylaryl group with up to 30 carbon atoms, a substituted or unsubstituted heteroaryl group with up to 10 carbon, oxygen, nitrogen, or sulfur atoms, a halogen atom (F, Cl, Br, or I), a hydroxyl group, a thiol group, a substituted or unsubstituted alkoxy group with 1 to 20 carbon atoms, an amino group (NR₂R₃), a thioether group (SR₄), a sulfoxy group (SOR₄), a sulfone group (SO₂R₄), a carboxylic acid group or a salt thereof (CO₂⁻M⁺, with M⁺ being a suitable cation), a carboxyamide group (CONR₂R₃), an acylamino group (NR₂COR₄), an acyl group (COR₄), an acyloxy group (OCOR₄), or a sulfonamido group (SO₂NR₂R₃), where R₂ and R₃ are independently a hydrogen, an alkyl group with up to 20 atoms, or an aryl group with up to 10 atoms and R₄ is an alkyl group with up to 20 atoms, or an aryl group with up to 10 atoms. The mercaptotriazole compounds can be represented by the following general formula:

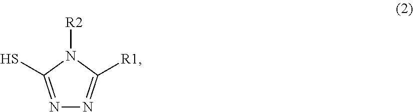

where R1 and R2 are independently hydrogen, a substituted or unsubstituted alkyl group comprising from 1 to 20 carbon atoms, a substituted or unsubstituted aryl group with up to 10 carbon atoms, a substituted or unsubstituted alkylaryl group with up to 30 carbon atoms, a substituted or unsubstituted heteroaryl group with up to 10 carbon, oxygen, nitrogen, or sulfur atoms, a halogen atom (F, Cl, Br, or I), a hydroxyl group, a thiol group, a substituted or unsubstituted alkoxy group with 1 to 20 carbon atoms, an amino group (NR₃R₄), a thioether group (SR₅), a sulfoxy group (SOR₅), a sulfone group (SO₂R₅), a carboxylic acid group or a salt thereof (CO₂⁻M⁺, with M⁺ being a suitable cation), a carboxyamide group (CONR₃R₄), an acylamino group (NR₄COR₅), an acyl group (COR₅), an acyloxy group (OCOR₅), or a sulfonamido group (SO₂NR₃R₄), where R₃ and R₄ are independently a hydrogen, an alkyl group with up to 20 atoms, or an aryl group with up to 10 atoms and R₅ is an alkyl group with up to 20 atoms, or an aryl group with up to 10 atoms.

Tetrazole disulfides have been identified as antifogging agents in photographic developers, as described in U.S. Pat. No. 2,453,087 to Dersch et al., entitled “Photographic Developers Containing Tetrazolyl Disulfides as Antifogging Agents,” incorporated herein by reference. The '661 application associates these compounds as potential photo-stabilizing agents. As described in the Example below, these compounds have been found to be very effective stabilizing agents for coating layers associated with sparse metal conductive layers. These compounds can be represented by the following formula:

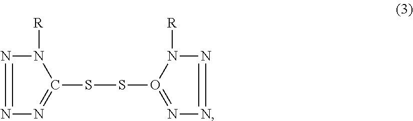

where R is a hydrocarbon moiety, such as methyl, ethyl, propyl, isopropyl, butyl, isobutyl, sec-butyl, tert-butyl, amyl, hexyl, octyl, nonyl, allyl, butenyl, pentenyl, hexenyl, phenyl, tolyl, naphthyl, diphenyl, benzyl, methyl benzyl, ethyl benzyl, or the like. The embodiment with R being a phenyl group (5,5′-dithiobis(1-phenyl-1H-tetrazole), CAS Number 5117-07-7) is exemplified in the Examples below and can be represented by the following formula,

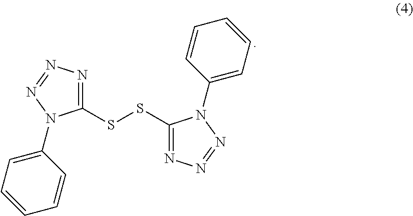 [SMILES: c1ccc(-n2nnnc2SSc2nnnn2-c2ccccc2)cc1]

Perfluoroalkylthiols have been found to be promising stabilization agents. Suitable compositions can be represented by the formula:

R_{F}—R—SH (5),

where R═—(CH₂)ₙ—, where 0≦n<5, and R_{F} is a perfluoro alkyl group, which can be linear or branched generally comprising 1 to 30 carbon atoms, such as trifluoromethyl, perfluoroethyl, perfluorohexyl, perfluorodecyl, perfluorhexadecyl, and the like. 2-Perfluorodecyl ethyl thiol (CAS Number 34451-28-0) is exemplified in the Examples below. Generally, the perfluoroalkylthiol compound is selected to be soluble in the solvent used to deliver the compound.

A further class of promising stabilization compounds are phthalazine and derivatives thereof Phthalazine (CAS Number 253-52-1) is represented by the following formula:

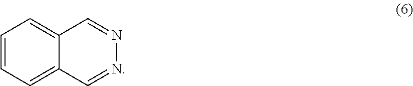

Suitable derivatives include, for example, halogenated phthalazine, including, for example, the 1,4-halogenated compounds, such as 1,4-dichlorophthalazine (CAS Number 4752-10-7). Phthalazine is exemplified in the Examples below.

It has been found that combinations of a hindered amine light stabilizers (HALS) and a hindered phenol antioxidant can be effective as stabilizers for sparse metal conductive layers. Hindered amines refer, for example, to derivatives of 2,2,6,6-tertamethyl piperidine ((CH₂)₅NH heterocycle). Commercial hindered amine compounds are available as antioxidants, such as some of the TINUVIN™ line of additives from BASF and a wide range of other suppliers are available. TINUVIN™ 123 (decanedioic acid, 2,2,6,6-tertamethyl-1-(octyloxy)-4-piperidinyl)ester) is exemplified in the Examples below. Hinder amine light stabilizers are known as polymer stabilizers. Hindered phenol antioxidants can be derivatives of 2,6-di-tert-butylphenol. Commercial hindered phenol antioxidants are commercially available, such as certain IRGANOX™ line of compounds from BASF, although a range of other suppliers are known. IRGANOX™ MD 1024 (2′-3-bis[[3-[3,5-di-tert-butyl-4-hydroxyphenyl]propionyl]]propionohydrazide) is exemplified in the Examples below. Surprisingly, alone the hindered amine light stabilizer and the hinder phenol antioxidant were not found to be particularly effective, but a blend of these was found to work very well with respect to stabilizing the sparse metal conductive layer with respect to conductivity. Hindered phenols generally are mentioned in the '661 application cited above.

A further class of stabilization compositions is polysulfide salts, such as potassium polysulfide, K₂Sₓ. These compositions are commercially available. Potassium polysulfide is exemplified below.

Photoacid generators produce acidic products when exposed to light of appropriate wavelength. Commercial photoacid generators are commercially available. For example, a range of photoacid generators are available from BASF under the trade name IRGACURE® PAG. In general, triaryl-substituted sulfonium complex salts are photoacid generators which may be used as stabilization compositions. These include, but are not limited to: triphenyl sulfonium tetrafluoroborate, triphenylsulfonium hexafluorophosphate, triphenylsulfonium hexafluoroantimonate, tritolysulfonium hexafluorophosphate, anisyldiphenylsulfonium hexafluoroantimonate, 4-butoxyphenyidiphenylsulfonium tetrafluoroborate, 4-chlorophenyl diphenylsulfonium hexafluoroantimonate, 4-acetoxy-phenyldiphenylsulfonium tetrafluoroborate, 4-acetamidophenyldiphenylsulfonium tetrafluoroborate. Photoacid generators are also available from Polyset Company, such as PC-2506, which is sold as a mixture of diaryliodonium hexafluoroantimonate salts and is exemplified below. Other examples of iodonium photoacid generators include but are not limited to: diphenyliodonium hexafluoroarsenate, diphenyl iodonium hexafluoroantimonate, diphenyliodonium hexafluorophosphate, diphenyliodonium trifluoroacetate, 4-trifluoromethylphenylphenyliodonium tetrafluoroborate, ditolyliodonium hexafluorophosphate, di(4-methoxyphenyl)iodonium hexafluoroantimonate, diphenyliodonium trifluoromethane sulfonate, di(t-butylphenyl)iodonium hexafluoroantimonate, di(t-butylphenyl)iodonium trifluoromethane sulfonate, (4-methylphenyl)phenyliodonium tetrafluoroborate, di-(2,4-dimethylphenyl)iodonium hexafluoroantimonate, di-(4-t-butylphenyl)iodonium hexafluoro antimonate, and 2,2′-diphenyliodonium hexafluorophosphate.

### Sparse Metal Conductive Layers

Sparse metal conductive layers are generally formed from metal nanowires. With sufficient loading and selected nanowire properties, reasonable electrical conductivity can be achieved with the nanowires with corresponding appropriate optical properties. It is expected that the stabilized film structures described herein can yield desirable performance for films with various sparse metal conductive structures. However, particularly desirable properties have been achieved with fused metal nanostructured networks.

As summarized above, several practical approaches have been developed to accomplish the metal nanowire fusing. The metal loading can be balanced to achieve desirable levels of electrical conductivity with good optical properties. In general, the metal nanowire processing can be accomplished through deposition of two inks with the first ink comprising the metal nanowires and the second ink comprising a fusing composition, or through the deposition of an ink that combines the fusing elements into the metal nanowire dispersion. The inks may or may not further comprise additional processing aids, binders or the like. Suitable patterning approaches can be selected to be suitable for the particular ink system.

In general, one or more solutions or inks for the formation of the metal nanostructured network can collectively comprise well dispersed metal nanowires, a fusing agent, and optional additional components, for example, a polymer binder, a crosslinking agent, a wetting agent, e.g., a surfactant, a thickener, a dispersant, other optional additives or combinations thereof. The solvent for the metal nanowire ink and/or the fusing solution if distinct from the nanowire ink can comprise an aqueous solvent, an organic solvent or mixtures thereof. In particular, suitable solvents include, for example, water, alcohols, ketones, esters, ethers, such as glycol ethers, aromatic compounds, alkanes, and the like and mixtures thereof. Specific solvents include, for example, water, ethanol, isopropyl alcohol, isobutyl alcohol, tertiary butyl alcohol, methyl ethyl ketone, glycol ethers, methyl isobutyl ketone, toluene, hexane, ethyl acetate, butyl acetate, ethyl lactate, PGMEA (2-methoxy-1-methylethylacetate), or mixtures thereof. While the solvent should be selected based on the ability to form a good dispersion of metal nanowires, the solvents should also be compatible with the other selected additives so that the additives are soluble in the solvent. For embodiments in which the fusing agent is included in a single solution with the metal nanowires, the solvent or a component thereof may or may not be a significant component of the fusing solution, such as alcohols and can be selected accordingly if desired.

The metal nanowire ink, in either a one ink or two ink configuration, can include from about 0.01 to about 1 weight percent metal nanowires, in further embodiments from about 0.02 to about 0.75 weight percent metal nanowires and in additional embodiments from about 0.04 to about 0.5 weight percent metal nanowires. A person of ordinary skill in the art will recognize that additional ranges of metal nanowire concentrations within the explicit ranges above are contemplated and are within the present disclosure. The concentration of metal nanowires influences the loading of metal on the substrate surface as well as the physical properties of the ink.

In general, the nanowires can be formed from a range of metals, such as silver, gold, indium, tin, iron, cobalt, platinum, palladium, nickel, cobalt, titanium, copper and alloys thereof, which can be desirable due to high electrical conductivity. Commercial metal nanowires are available from Sigma-Aldrich (Missouri, USA), Cangzhou Nano-Channel Material Co., Ltd. (China), Blue Nano (North Carolina, U.S.A.), EMFUTUR (Spain), Seashell Technologies (California, U.S.A.), Aiden (Korea), Nanocomposix (U.S.A.), Nanopyxis (Korea), K&B (Korea), ACS Materials (China), KeChuang Advanced Materials (China), and Nanotrons (USA). Alternatively, silver nanowires can also be synthesized using a variety of known synthesis routes or variations thereof. Silver in particular provides excellent electrical conductivity, and commercial silver nanowires are available. To have good transparency and low haze, it is desirable for the nanowires to have a range of small diameters. In particular, it is desirable for the metal nanowires to have an average diameter of no more than about 250 nm, in further embodiments no more than about 150 nm, and in other embodiments from about 10 nm to about 120 nm. With respect to average length, nanowires with a longer length are expected to provide better electrical conductivity within a network. In general, the metal nanowires can have an average length of at least a micron, in further embodiments, at least 2.5 microns and in other embodiments from about 5 microns to about 100 microns, although improved synthesis techniques developed in the future may make longer nanowires possible. An aspect ratio can be specified as the ratio of the average length divided by the average diameter, and in some embodiments, the nanowires can have an aspect ratio of at least about 25, in further embodiments from about 50 to about 10,000 and in additional embodiments from about 100 to about 2000. A person of ordinary skill in the art will recognize that additional ranges of nanowire dimensions within the explicit ranges above are contemplated and are within the present disclosure.

Polymer binders and the solvents are generally selected consistently such that the polymer binder is soluble or dispersible in the solvent. In appropriate embodiments, the metal nanowire ink generally comprises from about 0.02 to about 5 weight percent binder, in further embodiments from about 0.05 to about 4 weight percent binder and in additional embodiments from about 0.1 to about 2.5 weight percent polymer binder. In some embodiments, the polymer binder comprises a crosslinkable organic polymer, such as a radiation crosslinkable organic polymer and/or a heat curable organic binder. To facilitate the crosslinking of the binder, the metal nanowire ink can comprise in some embodiments from about 0.0005 wt % to about 1 wt % of a crosslinking agent, in further embodiments from about 0.002 wt % to about 0.5 wt % and in additional embodiments from about 0.005 to about 0.25 wt %. The nanowire ink can optionally comprise a rheology modifying agent or combinations thereof. In some embodiments, the ink can comprise a wetting agent or surfactant to lower the surface tension, and a wetting agent can be useful to improve coating properties. The wetting agent generally is soluble in the solvent. In some embodiments, the nanowire ink can comprise from about 0.01 weight percent to about 1 weight percent wetting agent, in further embodiments from about 0.02 to about 0.75 weight percent and in other embodiments from about 0.03 to about 0.6 weight percent wetting agent. A thickener can be used optionally as a rheology modifying agent to stabilize the dispersion and reduce or eliminate settling. In some embodiments, the nanowire ink can comprise optionally from about 0.05 to about 5 weight percent thickener, in further embodiments from about 0.075 to about 4 weight percent and in other embodiments from about 0.1 to about 3 weight percent thickener. A person of ordinary skill in the art will recognize that additional ranges of binder, wetting agent and thickening agent concentrations within the explicit ranges above are contemplated and are within the present disclosure.

A range of polymer binders can be suitable for dissolving/dispersing in a solvent for the metal nanowires, and suitable binders include polymers that have been developed for coating applications. Hard coat polymers, e.g., radiation curable coatings, are commercially available, for example as hard coat materials for a range of application, that can be selected for dissolving in aqueous or non-aqueous solvents. Suitable classes of radiation curable polymers and/or heat curable polymers include, for example, polyurethanes, acrylic resins, acrylic copolymers, cellulose ethers and esters, other water insoluble structural polysaccharides, polyethers, polyesters, epoxy containing polymers, and mixtures thereof. Examples of commercial polymer binders include, for example, NEOCRYL® brand acrylic resin (DMS NeoResins), JONCRYL® brand acrylic copolymers (BASF Resins), ELVACITE® brand acrylic resin (Lucite International), SANCURE® brand urethanes (Lubrizol Advanced Materials), cellulose acetate butyrate polymers (CAB brands from Eastman™ Chemical), BAYHYDROL™ brand polyurethane dispersions (Bayer Material Science), UCECOAT® brand polyurethane dispersions (Cytec Industries, Inc.), MOWITOL® brand polyvinyl butyral (Kuraray America, Inc.), cellulose ethers, e.g., ethyl cellulose or hydroxypropyl methyl cellulose, other polysaccharide based polymers such as Chitosan and pectin, synthetic polymers like polyvinyl acetate, and the like. The polymer binders can be self-crosslinking upon exposure to radiation, and/or they can be crosslinked with a photoinitiator or other crosslinking agent. In some embodiments, photocrosslinkers may form radicals upon exposure to radiation, and the radicals then induce crosslinking reactions based on radical polymerization mechanisms. Suitable photoinitiators include, for example, commercially available products, such as IRGACURE® brand (BASF), GENOCURE™ brand (Rahn USA Corp.), and DOUBLECURE® brand (Double Bond Chemical Ind., Co, Ltd.), combinations thereof or the like.

Wetting agents can be used to improve the coatability of the metal nanowire inks as well as the quality of the metal nanowire dispersion. In particular, the wetting agents can lower the surface energy of the ink so that the ink spreads well onto a surface following coating. Wetting agents can be surfactants and/or dispersants. Surfactants are a class of materials that function to lower surface energy, and surfactants can improve solubility of materials. Surfactants generally have a hydrophilic portion of the molecule and a hydrophobic portion of the molecule that contributes to its properties. A wide range of surfactants, such as nonionic surfactants, cationic surfactant, anionic surfactants, zwitterionic surfactants, are commercially available. In some embodiments, if properties associated with surfactants are not an issue, non-surfactant wetting agents, e.g., dispersants, are also known in the art and can be effective to improve the wetting ability of the inks. Suitable commercial wetting agents include, for example, COATOSIL™ brand epoxy functionalized silane oligomers (Momentum Performance Materials), SILWET™ brand organosilicone surfactant (Momentum Performance Materials), THETAWET™ brand short chain non-ionic fluorosurfactants (ICT Industries, Inc.), ZETASPERSE® brand polymeric dispersants (Air Products Inc.), SOLSPERSE® brand polymeric dispersants (Lubrizol), XOANONS WE-D545 surfactant (Anhui Xoanons Chemical Co., Ltd), EFKA™ PU 4009 polymeric dispersant (BASF), MASURF FP-815 CP, MASURF FS-910 (Mason Chemicals), NOVEC™ FC-4430 fluorinated surfactant (3M), mixtures thereof, and the like.

Thickeners can be used to improve the stability, of the dispersion by reducing or eliminating settling of the solids from the metal nanowire inks. Thickeners may or may not significantly change the viscosity or other fluid properties of the ink. Suitable thickeners are commercially available and include, for example, CRAYVALLAC™ brand of modified urea such as LA-100 (Cray Valley Acrylics, USA), polyacrylamide, THIXOL™ 53L brand acrylic thickener, COAPUR™ 2025, COAPUR™ 830W, COAPUR™ 6050, COAPUR™ XS71 (Coatex, Inc.), BYK® brand of modified urea (BYK Additives), Acrysol DR 73, Acrysol RM-995, Acrysol RM-8W (Dow Coating Materials), Aquaflow NHS-300, Aquaflow XLS-530 hydrophobically modified polyether thickeners (Ashland Inc.), Borchi Gel L 75 N, Borchi Gel PW25 (OMG Borchers), and the like.

Additional additives can be added to the metal nanowire ink, generally each in an amount of no more than about 5 weight percent, in further embodiments no more than about 2 weight percent and in further embodiments no more than about 1 weight percent. Other additives can include, for example, anti-oxidants, UV stabilizers, defoamers or anti-foaming agents, anti-settling agents, viscosity modifying agents, or the like.

As noted above, fusing of the metal nanowires can be accomplished through various agents. Without wanting to be limited by theory, the fusing agents are believed to mobilize metal ions, and the free energy seems to be lowered in the fusing process. Excessive metal migration or growth may lead in some embodiments to a degeneration of the optical properties, so desirable results can be achieved through a shift in equilibrium in a reasonably controlled way, generally for a short period of time, to generate sufficient fusing to obtain desired electrical conductivity while maintaining desired optical properties. In some embodiments, initiation of the fusing process can be controlled through a partial drying of the solutions to increase concentrations of the components, and quenching of the fusing process can be accomplished, for example, through rinsing or more completing drying of the metal layer. The fusing agent can be incorporated into a single ink along with the metal nanowires. The one ink solution can provide appropriate control of the fusing process.

In embodiments of particular interest, a process is used in which a sparse nanowire film is initially deposited and subsequent processing with or without depositing another ink provides for the fusing of the metal nanowires into a metal nanostructured network, which is electrically conducting. The fusing process can be performed with controlled exposure to a fusing vapor and/or through the deposition of a fusing agent in solution. Sparse metal conductive layers are generally formed on a selected substrate surface. The as deposited nanowire film is dried to remove the solvent. Processing can be adapted for patterning of the film as described further below.

For the deposition of the metal nanowire ink, any reasonable deposition approach can be used, such as dip coating, spray coating, knife edge coating, bar coating, Meyer-rod coating, slot-die, gravure printing, spin coating or the like. The ink can have properties, such as viscosity, adjusted appropriately with additives for the desired deposition approach. Similarly, the deposition approach directs the amount of liquid deposited, and the concentration of the ink can be adjusted to provide the desired loading of metal nanowires on the surface. After forming the coating with the dispersion, the sparse metal conductive layer can be dried to remove the liquid.

The films can be dried, for example, with a heat gun, an oven, a thermal lamp or the like, although the films that can be air dried can be desired in some embodiments. In some embodiments, the films can be heated to temperatures from about 50° C. to about 150° C. during drying. After drying, the films can be washed one or more times, for example, with an alcohol or other solvent or solvent blend, such as ethanol or isopropyl alcohol, to removed excess solids to lower haze. Patterning can be achieved in several convenient ways. For example, printing of the metal nanowires can directly result in patterning. Additionally or alternatively, lithographic techniques can be used to remove portions of the metal nanowires, prior to or after fusing, to form a pattern.

### Transparent Film Electrical and Optical Properties

The fused metal nanostructured networks can provide low electrical resistance while providing good optical properties. Thus, the films can be useful as transparent conductive electrodes or the like. The transparent conductive electrodes can be suitable for a range of applications such as electrodes along light receiving surfaces of solar cells. For displays and in particular for touch screens, the films can be patterned to provide electrically conductive patterns formed by the film. The substrate with the patterned film, generally has good optical properties at the respective portions of the pattern.

Electrical resistance of thin films can be expressed as a sheet resistance, which is reported in units of ohms per square (Ω/□ or ohms/sq) to distinguish the values from bulk electrical resistance values according to parameters related to the measurement process. Sheet resistance of films is generally measured using a four point probe measurement or another suitable process. In some embodiments, the fused metal nanowire networks can have a sheet resistance of no more than about 300 ohms/sq, in further embodiments no more than about 200 ohms/sq, in additional embodiments no more than about 100 ohms/sq and in other embodiments no more than about 60 ohms/sq. A person of ordinary skill in the art will recognize that additional ranges of sheet resistance within the explicit ranges above are contemplated and are within the present disclosure. Depending on the particular application, commercial specifications for sheet resistances for use in a device may not be necessarily directed to lower values of sheet resistance such as when additional cost may be involved, and current commercially relevant values may be for example, 270 ohms/sq, versus 150 ohms/sq, versus 100 ohms/sq, versus 50 ohms/sq, versus 40 ohms/sq, versus 30 ohms/sq or less as target values for different quality and/or size touch screens, and each of these values defines a range between the specific values as end points of the range, such as 270 ohms/sq to 150 ohms/sq, 270 ohms/sq to 100 ohms/sq, 150 ohms/sq to 100 ohms/sq and the like with 15 particular ranges being defined. Thus, lower cost films may be suitable for certain applications in exchange for modestly higher sheet resistance values. In general, sheet resistance can be reduced by increasing the loading of nanowires, but an increased loading may not be desirable from other perspectives, and metal loading is only one factor among many for achieving low values of sheet resistance.

For applications as transparent conductive films, it is desirable for the fused metal nanowire networks to maintain good optical transparency. In principle, optical transparency is inversely related to the loading with higher loadings leading to a reduction in transparency, although processing of the network can also significantly affect the transparency. Also, polymer binders and other additives can be selected to maintain good optical transparency. The optical transparency can be evaluated relative to the transmitted light through the substrate. For example, the transparency of the conductive film described herein can be measured by using a UV-Visible spectrophotometer and measuring the total transmission through the conductive film and support substrate. Transmittance is the ratio of the transmitted light intensity (I) to the incident light intensity (Iₒ). The transmittance through the film (T_{film}) can be estimated by dividing the total transmittance (T) measured by the transmittance through the support substrate (T_{sub}). (T=I/Iₒ and T/T_{sub}=(I/Iₒ)/(I_{sub}/Iₒ)=I/I_{sub}=T_{film}) Thus, the reported total transmissions can be corrected to remove the transmission through the substrate to obtain transmissions of the film alone. While it is generally desirable to have good optical transparency across the visible spectrum, for convenience, optical transmission can be reported at 550 nm wavelength of light. Alternatively or additionally, transmission can be reported as total transmittance from 400 nm to 700 nm wavelength of light, and such results are reported in the Examples below. In general, for the fused metal nanowire films, the measurements of 550 nm transmittance and total transmittance from 400 nm to 700 nm (or just “total transmittance” for convenience) are not qualitatively different. In some embodiments, the film formed by the fused network has a total transmittance (TT %) of at least 80%, in further embodiments at least about 85%, in additional embodiments, at least about 90%, in other embodiments at least about 94% and in some embodiments from about 95% to about 99%. Transparency of the films on a transparent polymer substrate can be evaluated using the standard ASTM D1003 (“Standard Test Method for Haze and Luminous Transmittance of Transparent Plastics”), incorporated herein by reference. A person or ordinary skill in the art will recognize that additional ranges of transmittance within the explicit ranges above are contemplated and are within the present disclosure. When adjusting the measured optical properties for the films in the Examples below for the substrate, the films have very good transmission and haze values, which are achieved along with the low sheet resistances observed.

The fused metal networks can also have low haze along with high transmission of visible light while having desirably low sheet resistance. Haze can be measured using a hazemeter based on ASTM D1003 referenced above, and the haze contribution of the substrate can be removed to provide haze values of the transparent conductive film. In some embodiments, the sintered network film can have a haze value of no more than about 1.2%, in further embodiments no more than about 1.1%, in additional embodiments no more than about 1.0% and in other embodiments from about 0.9% to about 0.2%. As described in the Examples, with appropriately selected silver nanowires very low values of haze and sheet resistance have been simultaneously achieved. The loading can be adjusted to balance the sheet resistance and the haze values with very low haze values possible with still good sheet resistance values. Specifically, haze values of no more than 0.8%, and in further embodiments from about 0.4% to about 0.7%, can be achieved with values of sheet resistance of at least about 45 ohms/sq. Also, haze values of 0.7% to about 1.2%, and in some embodiments from about 0.75% to about 1.05%, can be achieved with sheet resistance values of from about 30 ohms/sq to about 45 ohms/sq. All of these films maintained good optical transparency. A person of ordinary skill in the art will recognize that additional ranges of haze within the explicit ranges above are contemplated and are within the present disclosure.

With respect to the corresponding properties of the multilayered films, the additional components are generally selected to have a small effect on the optical properties, and various coatings and substrates are commercially available for use in transparent elements. Suitable optical coatings, substrates and associated materials are summarized above. Some of the structural material can be electrically insulating, and if thicker insulating layers are used, the film can be patterned to provide locations where gaps or voids through the insulating layers can provide access and electrical contact to the otherwise embedded electrically conductive element. Some components of the ultimate device can be covered from view with an opaque or translucent covering to hide from view portions of the structure, such as connections through to the electrically conductive transparent elements. The covering can shield the conductive layer form light, but heats up due to light absorption, and cover tape and edges at the transition between transparent and covered regions can have stability issues that are addressed in the Examples.

### Transparent Electrically Conductive Film Stability and Stability Testing

In use, it is desirable for the transparent conductive films to last a commercially acceptable time, such as the lifetime of the corresponding device. The stabilization compositions and structures described herein have this objective in view, and the properties of the sparse metal conductive layers are sufficiently maintained. To test the performance, accelerated aging procedures can be used to provide objective evaluation over a reasonable period of time. These tests can be performed using commercially available environmental test equipment.

A selected test, which is used in the Examples involves black standard temperature of 60° C. (a setting of the apparatus), an air temperature of 38° C., a relative humidity of 50% and an irradiance of 60 W/m² from (300 nm to 400 nm) from xenon lamps with a daylight filter. A variety of suitable test equipment is commercially available, such as Atlas Suntest™ XXL apparatus (Atlas Material Testing Solutions, Chicago, Ill., USA) and a SUGA environmental test instrument, Super Xenon Weather Meter, SX75 (SUGA Test Instruments Co., Limited, Japan).

Under the test conditions specified in the previous paragraph, a sample can be evaluated by the change in sheet resistance as a function of time. The values can be normalized to the initial sheet resistance to focus on the time evolution. So generally the time evolution is plotted for Rₜ/R₀, where Rₜ is the time evolving sheet resistance measurement and R₀ is the initial value of sheet resistance. In some embodiments, the value of Rₜ/R₀ can be no more than a value of 1.8 and no less than a value of 0.5 after 1000 hour, in further embodiments no more than a value of 1.6 and in additional embodiment no more than a value of 1.4 and no less than a value of 0.7 after 1000 hours of environmental testing. From another perspective, the value of Rₜ/R₀ can be no more than a value of 1.5 and no less than 0.5 after about 1000 hours, in further embodiments no more than a value of 1.5 and no less than 0.5 after about 1500 hours and in additional embodiments no more than a value of 1.5 and no less than 0.5 after about 2000 hours of environmental testing. In additional embodiments, the value of Rₜ/R₀ can be no more than a value of 1.2 after about 750 hours. A person of ordinary skill in the art will recognize that additional ranges of Rₜ/R₀ and stability times within the explicit ranges above are contemplated and are within the present disclosure.

One useful feature of stabilized conductive films is that the change in Rₜ/R₀ is gradual, such that no catastrophic failure of the film is to happen within a short period of time under testing. In some embodiments, the change in Rₜ/R₀ remains less than 0.5 per any 100 hour increments at a total of about 2000 hrs, in further embodiment no more than about 0.3 and in other embodiments no more than about 0.2 per any 100 hour increments at a total of about 2000 hours. A person of ordinary skill in the art will recognize that additional ranges of stability over time increments within the explicit ranges above are contemplated and are within the present disclosure.

### Touch Sensors

The transparent conductive films described herein can be effectively incorporated into touch sensors that can be adapted for touch screens used for many electronic devices. Some representative embodiments are generally described here, but the transparent conductive films can be adapted for other desired designs. A common feature of the touch sensors generally is the presence of two transparent conductive electrode structures in a spaced apart configuration in a natural state, i.e., when not being touched or otherwise externally contacted. For sensors operating based on capacitance, a dielectric layer is generally between the two electrode structures. Referring to FIG. 3, a representative capacitance based touch sensor 202 comprises a display component 204, an optional bottom substrate 206, a first transparent conductive electrode structure 208, a dielectric layer 210, such as a polymer or glass sheet, a second transparent conductive electrode structure 212, optional top cover 214, and measurement circuit 216 that measures capacitance changes associated with touching of the sensor. Referring to FIG. 4, a representative resistance based touch sensor 240 comprises a display component 242, an optional lower substrate 244, a first transparent conductive electrode structure 246, a second transparent conductive electrode structure 248, support structures 250, 252 that support the spaced apart configuration of the electrode structures in their natural configuration, upper cover layer 254 and resistance measuring circuit 256.

Display components 204, 242 can be, for example, LED based displays, LCD displays or other desired display components. Substrates 206, 244 and cover layers 212, 254 can be independently transparent polymer sheets or other transparent sheets. Support structures can be formed from a dielectric material, and the sensor structures can comprise additional supports to provide a desired stable device. Measurement circuits 214, 256 are known in the art.

Transparent conductive electrodes 206, 210, 246 and 248 can be effectively formed using fused metal networks, which can be patterned appropriately to form distinct sensors, although in some embodiments the fused metal networks form some transparent electrode structures while other transparent electrode structures in the device can comprise materials such as indium tin oxide, aluminum doped zinc oxide or the like. Fused metal networks can be effectively patterned as described herein, and it can be desirable for patterned films in one or more of the electrode structures to form the sensors such that the plurality of electrodes in a transparent conductive structure can be used to provide position information related to the touching process. The use of patterned transparent conductive electrodes for the formation of patterned touch sensors is described, for example, in U.S. Pat. No. 8,031,180 to Miyamoto et al., entitled “Touch Sensor, Display With Touch Sensor, and Method for Generating Position Data,” and published U.S. patent application 2012/0,073,947 to Sakata et al., entitled “Narrow Frame Touch Input Sheet, Manufacturing Method of Same, and Conductive Sheet Used in Narrow Frame Touch Input Sheet,” both of which are incorporated herein by reference.

### EXAMPLES

The following Examples make use of a single ink comprising a single ink comprising a solvent with a stable dispersion of silver nanowires, a polymer binder and a fusing solution. The silver nanowire ink was essentially as described in Example 5 of copending U.S. patent application Ser. No. 14/448,504 to Li et al., entitled “Metal Nanowire Inks for the Formation of Transparent Conductive Films With Fused Networks,” incorporated herein by reference. AgNW typically is present in the ink at a level between 0.1 to 1.0 wt % and the binder at about 0.01 to 1 wt %. The ink was slot coated onto a PET polyester film. After coating the nanowire inks, the films were then heated in an oven at 100° C. for 10 min to dry the films. The coating composition was similarly slot coated onto the fused metal nanostructured layer. Unless otherwise indicated, the concentration of a stabilization compounds was 0.02 wt % in solution and 2.67 wt % in the coating. The film was then cured with UV light. The particular coating solution was designed for the formation of fused metal nanostructured network with a sheet resistance of no more than about 100 ohms/sq. and a transparency of at least about 90%. But it is expected that the observed stability would correspondingly be observed for metal nanowire based conductive films. In all of the examples, the optical properties of the stabilized films are generally not significantly altered from the corresponding films without a chemical stabilization agent.

Three sets of experiments were performed with similar but somewhat different testing configurations. The two sets of experiments are sequentially discussed.

### First Set of Experiments

The tests were performed with a film having a PET substrate, a fused metal nanostructured layer, a polymer overcoat, an optically clear adhesive and a laminated polymer cover, which was a commercial hard coated PET polyester. Except as noted in specific examples, to the back of the PET substrate was applied another optically clear adhesive and an additional laminated hard coated polyester cover. The total thicknesses of the films were from about 450 microns to about 550 microns. All samples were formed in triplicate and average results are reported.

Accelerated weathering testing was performed in an Atlas Suntest™ XXL apparatus (Atlas Material Testing Solutions, Chicago, Ill., USA). The conditions in the testing apparatus had a black standard temperature of 60° C. (a setting of the apparatus), an air temperature of 38° C. a relative humidity of 50% and an irradiance of 60 W/m² from (300 nm to 400 nm) from xenon lamps with a daylight filter. The hard coated-PET back cover sheet was placed facing upward toward the light in the apparatus and covered with black tape, unless indicated otherwise.

### Example 1

### Transparent Conductive Films with Overcoats Having Stabilization Compositions

This example demonstrates the effectiveness of two stabilization compounds placed in an overcoat layer.

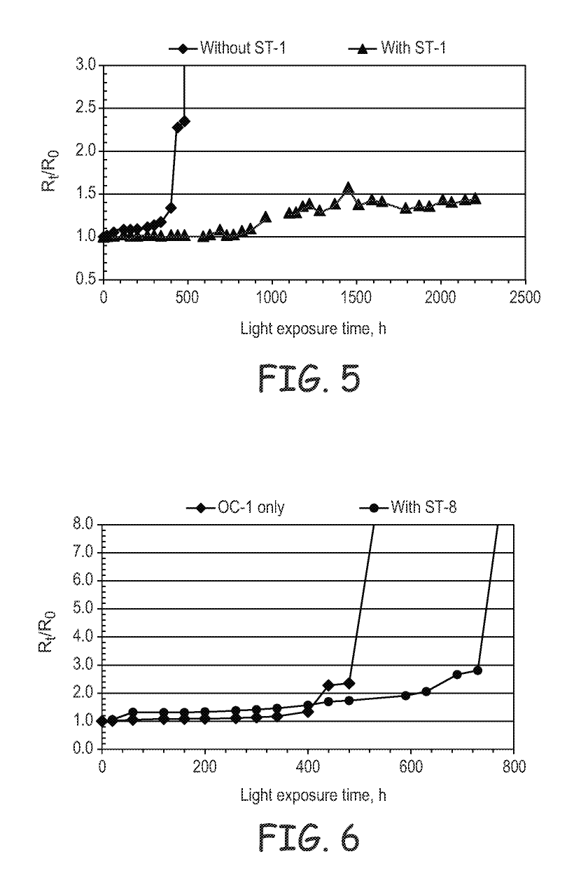

A set of samples was prepared with two different stabilizers as well as a set of films without any stabilizers, all with a commercial overcoat solution OC-1. The stabilization compounds were placed in the overcoat layer at a concentration of 2.67 wt % relative to the solids in the layer. The results for ST-1=5,5′-dithiobis(1-phenyl-1H-tetrazole) are shown in FIG. 5, and the results for ST-8=pentafluorobenzenethiol are shown in FIG. 6. The results for ST-1 demonstrate excellent stabilization to greater than 2000 hrs under the test conditions. The results for ST-8 are a significant improvement over the performance without a stabilization compound, but the results are not as good as the results obtained for ST-1.

### Example 2

### Overcoat Layers with Stabilization Compounds, Concentration Dependence

This example demonstrates that overcoats with a lower concentration of stabilization compound can effectively stabilize a sparse metal conductive layer relative to a greater concentration.

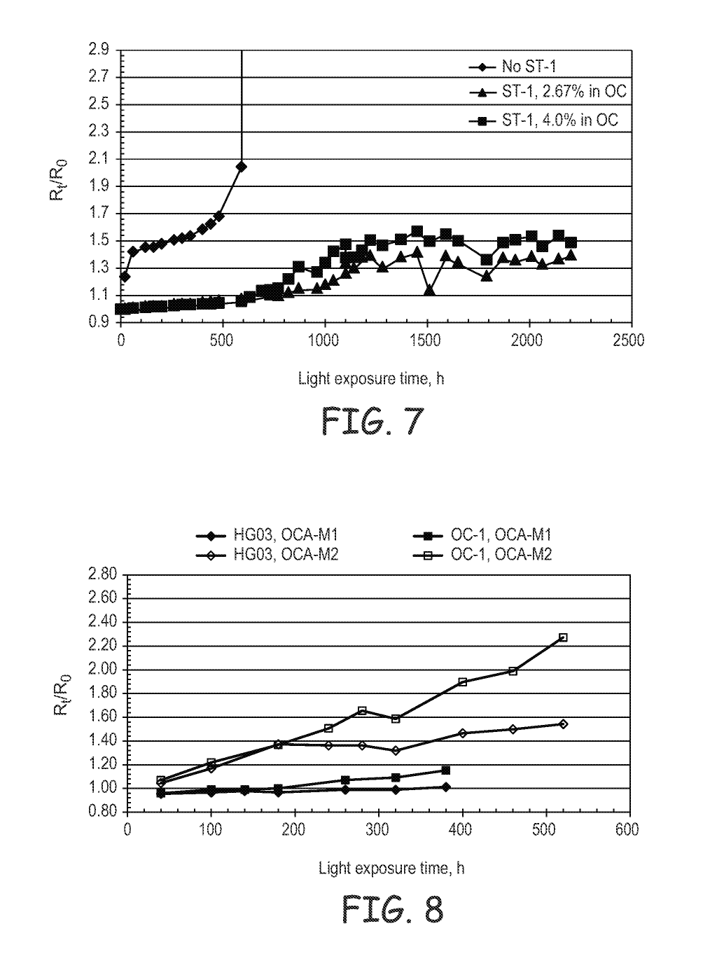

Example 1 was repeated with ST-1 stabilization compound at two concentrations, 4 wt % and 2.67 wt % relative to the solids. The results are given in FIG. 7. As can be seen in the Figure, the lower concentration of ST-1 resulted in better stabilization, although both concentrations resulted in important stabilization relative to the control sample.

### Example 3

### Stabilization Effects of Optically Conductive Adhesives

This example demonstrates that certain optically clear adhesives provide improved stabilization of sparse metal conductive layers.

Four sets of samples were prepared with two different optically clear adhesive tapes, OCA-M1=3M 8173KCL and OCA-M2=3M 8146-4, and two different overcoat polymers, commercial OC-1 and formulated HG03. The results are plotted in FIG. 8. The stabilization was similar with the two different overcoat polymers. The selection of OCA was more significant with much better results with OCA-M1, which is a two sided adhesive tape with a carrier layer embedded within the tape.

### Example 4

### Effect of Barrier Layer

This example explores the stabilization effect of a barrier film on top of the optically clear adhesive.

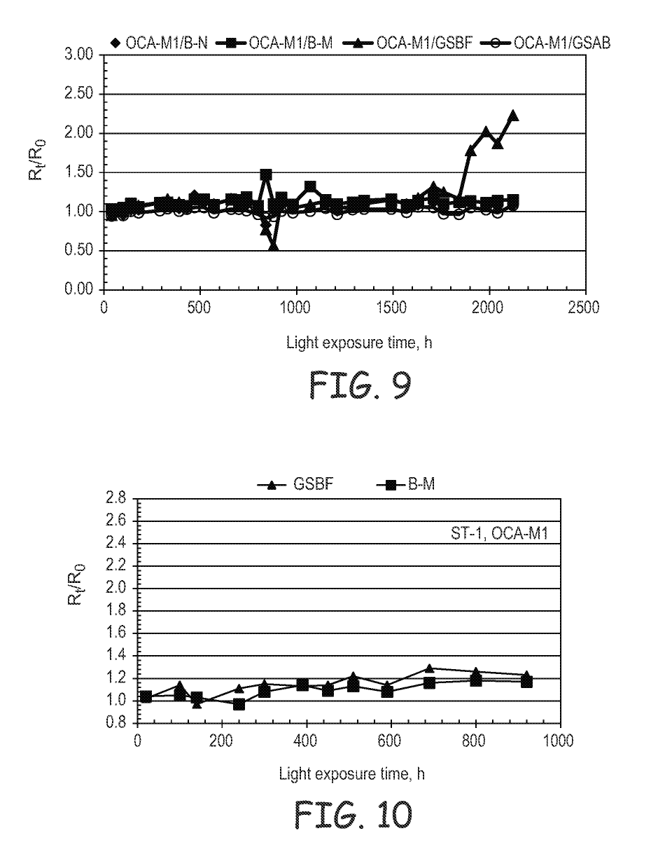

Samples were prepared with two commercial barrier layers (B-M and B-N) as the top cover and with two hard coated PET films, one at 2-mil (about 50 micron) thick (labeled GSBF), and the other at 5-mil (about 150 micron) thick (labeled GSAB), respectively. The stability results are plotted in FIG. 9. All of the films exhibited similar stability to 1800 hours at which time the samples with the thinner PET barrier layer began exhibiting significant resistance increase. Additional results on conduction stability are plotted in FIG. 10 for an overcoat with ST-1 stabilizer with an optically clear adhesive OCA-M1 and two different covers, hard coated PET (GSBF) and a commercial barrier film B-M.

### Example 5

### Effects of Tape Coverage

This example demonstrates the effect of coverage of the film with tape during testing.

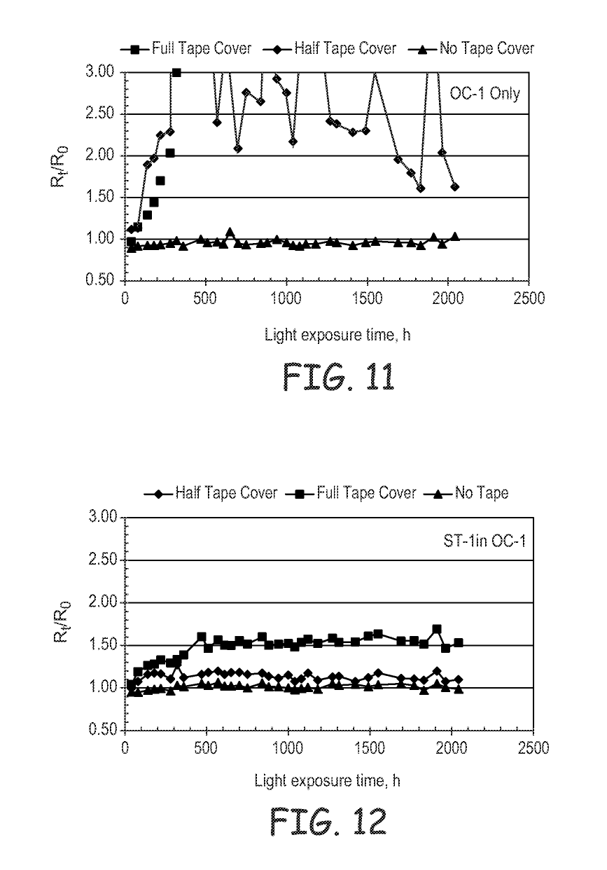

Referring to FIG. 11, the stability is shown with no stabilization compounds. As can be seen in the Figure, the film that is not covered with tape is sufficiently stabilized by the overlayers without a stabilization compound for 2000 hours in the testing apparatus. However, the samples with a half of a tape cover or a full tape cover exhibit significant instability in a relatively short period of time.

The same experiment was performed with ST-1 in the overcoat layer. The results are presented in FIG. 12. The presence of ST-1 stabilized the samples with a half tape cover and a full tape cover with the half tape coverage results exhibiting only a slight instability relative to the uncovered results.

### Example 6

### Phthalazine Stabilizer

This example explores the effectiveness of phthalazine (ST-9) as a stabilizer for sparse metal conductive layers.

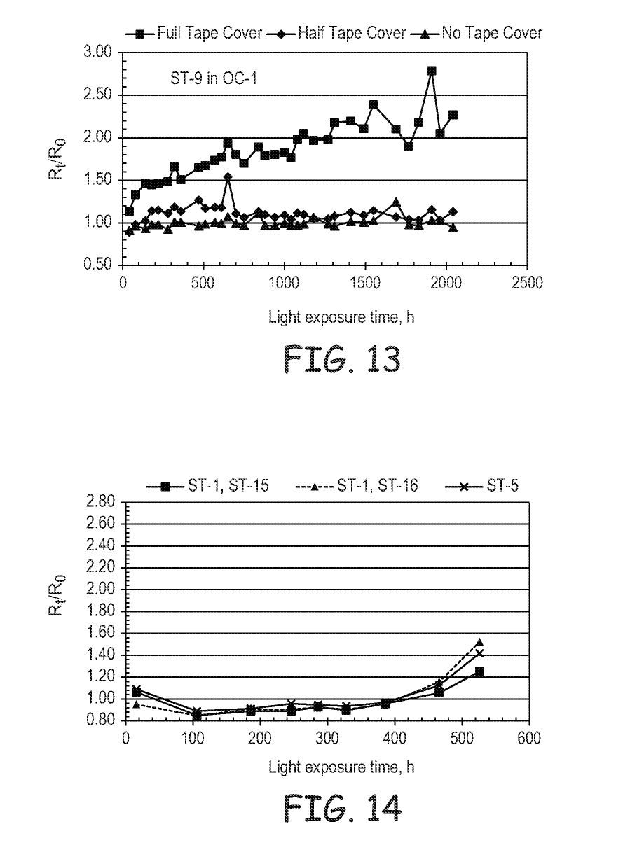

The samples were tested as described in Example 5. Specifically, three sets of samples were prepared with one sample set having no tape, one sample set having tape covering half the sample and one sample set being completely covered with tape. The results are plotted in FIG. 13. The phthalazine stabilizer exhibited very good stabilization for the samples covered with no tape or half covered with tape. For the samples fully covered with tape, the samples exhibited significant stabilization relative to the control without a stabilization compound in FIG. 11, but the stabilization was not as effective as ST-1 stabilizer as shown in FIG. 12.

### Example 7

### Stabilizers In Films Without OCA

The example explores stabilization for film samples without an optically clear adhesive or other covering over the overcoat.

The films were formed as described above without the addition of layers over the overcoat and with the overcoat facing the light source during testing. Three sets of samples were prepared with one set of samples prepared with a blend of ST-1 stabilizer with a first photoacid generator (PC-2506 from Polyset Co., N.Y., USA, diaryliodonium hexafluoroantimonate salts, ST-15), with a second set of samples prepared with a blend of ST-1 stabilizer with a second photoacid generator (triarylsulfonium hexafluoroantimonate salts from Sigma-Aldrich, ST-16), and with a third set of samples prepared with potassium polysulfide (Sigma-Aldrich, ST-5). The stabilization results are presented in FIG. 14. The films with a blend of ST-1 and ST-15 exhibited the best stability with the sample with ST-5 exhibiting the second best stability for these samples.

### Example 8

### Hindered Phenol and Hindered Amine Stabilizers

This example demonstrates the effectiveness of a blend of a hindered phenol antioxidant and a hindered amine UV stabilizer.

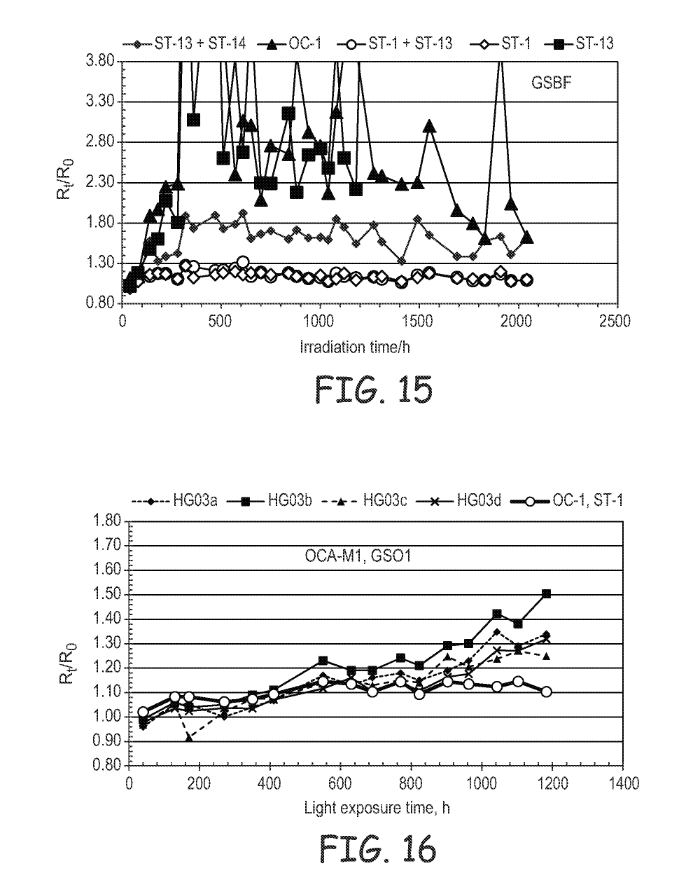

Film samples were prepared and tested as described in Example 1. Samples were prepared with no stabilizer, ST-1, a hindered amine only (ST-13), a blend of ST-1 and ST-13, and a blend of a hindered amine (ST-13) and a hindered phenol (ST-14). Stabilization compositions were introduced at a concentration of 0.1 wt % in the coating solution. The stabilization results are plotted in FIG. 15. The samples with ST-1 showed the best performance. The hindered amine alone resulted in no observable improvement in stability relative to the sample with no stabilization composition. While not plotted, stabilization with the hindered phenol only also did not result in a desirable degree of stabilization. However, the combination of the hindered phenol and the hindered amine resulted in good stabilization of the samples out to 2000 hours of testing.

### Example 9

### Roll-to-Roll Processing

This example demonstrates transparent conductive film stability on films coated using commercial roll-to-roll processing of the films. These films were formed with either OC-1 commercial overcoat material or HG03 custom made overcoat material. The HG03 coating material included a blend of a commercial UV crosslinkable acrylate hard coating composition with a cyclic-siloxane epoxy resin and the combination of ST-13 and ST-14 stabilizers. Epoxy acrylate hybrid hard coatings are described further, for example, in U.S. Pat. No. 4,348,462 to Chung, entitled “Abrasion Resistant Ultraviolet Light Curable Hard Coating Compositions,” U.S. Pat. No. 4,623,676 to Kistner, entitled “Protective Coating for Phototools,” and Sangermano et al., Macromolecular Materials and Engineering, Volume 293, pp 515-520, (2008), entitled “UV-Cured Interpenetrating Acrylic-Epoxy Polymer Networks: Preparation and Characterization,” all three of which are incorporated herein by reference. The set of samples using OC-1 included ST-1 in the overcoat while the other samples with HG03 contained a blend of ST-13 and ST-14 as stated above. The roll-to-roll coating was performed using a commercial roll-to-roll coater that applied the overcoat solutions to the sparse metal conductive layers. Four separate runs were performed for the HG03 samples, a-d. Optically clear adhesive OCA-M1 was used also together with a one-side hard coated PET (GS01) as protective layer. The results are presented in FIG. 16. The stabilization compositions applied through a roll-to-roll process generally show good performance but the use of ST-1 in OC-1 gives slightly better performance and stability was obtained over the 1200 test hours.

### Second set of Experiments

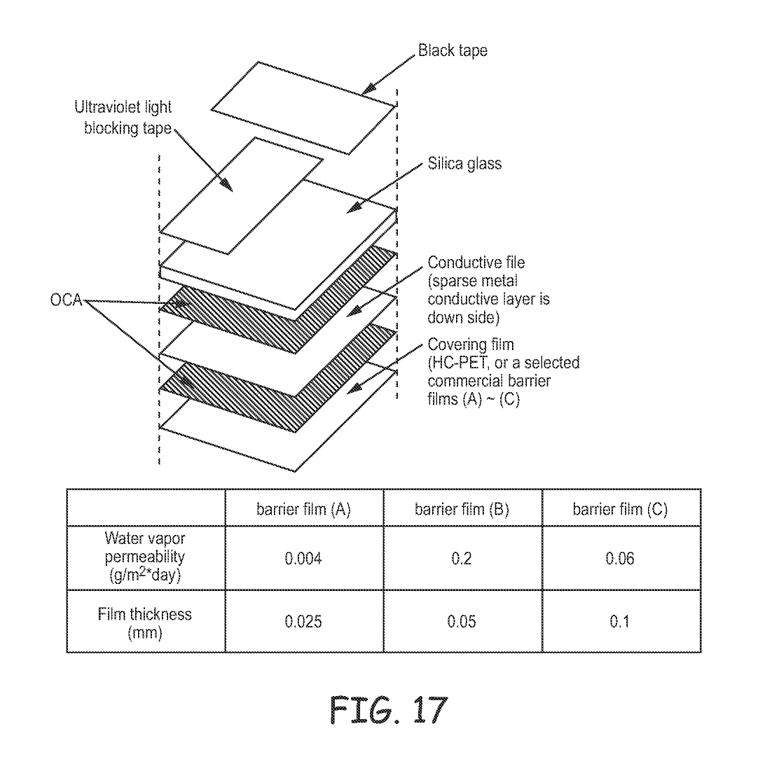

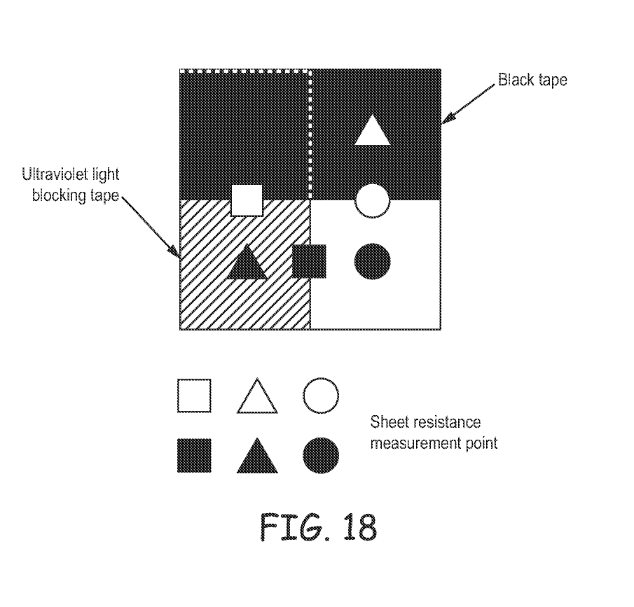

In a second set of experiments, the film stack was assembled as shown in FIG. 17. In these experiments, the films were formed with two layers of optically conductive adhesives (OCA). One layer of OCA was used to secure the substrate or base film to 0.7 mm thick layer of silica glass, and the other layer of OCA was used to secure a sparse metal conductive layer with a polymer overcoat to a hard coated PET film (HC-PET), or a selected commercial barrier films (A)˜(C). The water vapor permeability of these films are listed in FIG. 17. Half the surface of the glass was then covered with black tape and a half of the exposed area was covered with an ultraviolet light blocking tape. This left ¼ of the surface uncovered. A top view of the structure is shown in FIG. 18.

The film with the tape covers was placed in a SUGA environmental test instrument, Super Xenon Weather Meter, SX75 (SUGA Test Instruments Co., Limited, Japan), with the taped surface facing the lamp. The chamber was set at 65° C. (BST) with a 50% relative humidity. Sheet resistance measurements with a contactless resistance meter were performed at 6 points as noted in FIG. 18, which cover the three different regions along the top surface and three boundary regions. The sheet resistance then was monitored as a function of time.

### Example 10

### Effect of Barrier Film

This example demonstrates the stabilization effect of a barrier film on top of the optically clear adhesive.

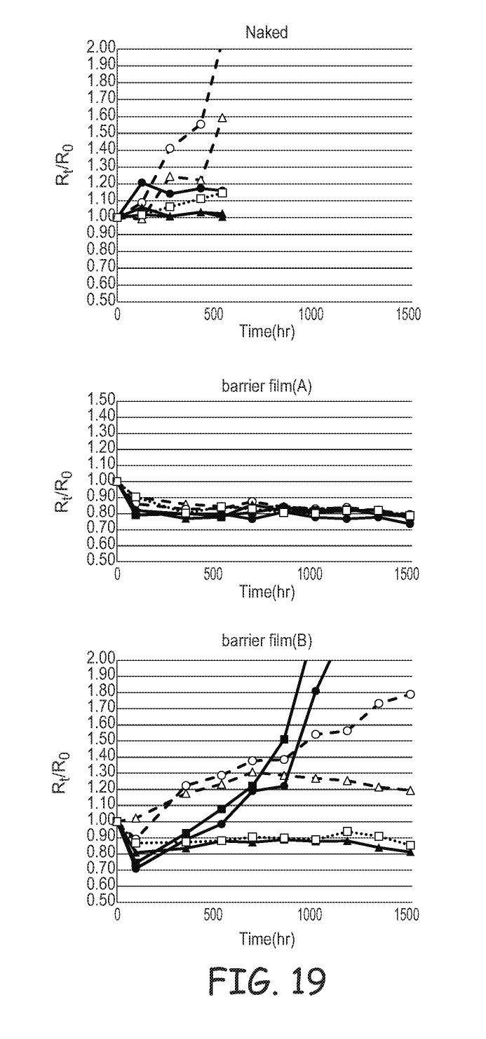

Samples were prepared with two barrier films whose water vapor permeability (WVP) is different. For comparison, naked samples, which don't have any covering film, were also prepared. Over coating layers of all samples were OC-1. The stability results are plotted in FIG. 19. A barrier film(A) whose WVP is 0.004 g/(m²·day) exhibited excellent stability to 1500 hr. A barrier film(B) whose WVP is 0.2 g/(m²·day) and naked samples exhibited significant resistance increase even at 500 hr.

### Example 11

### Overcoat Layers with Stabilization Compounds

This example demonstrates the stabilization effect of HG03 (incorporating ST-13+ST-14 blend).

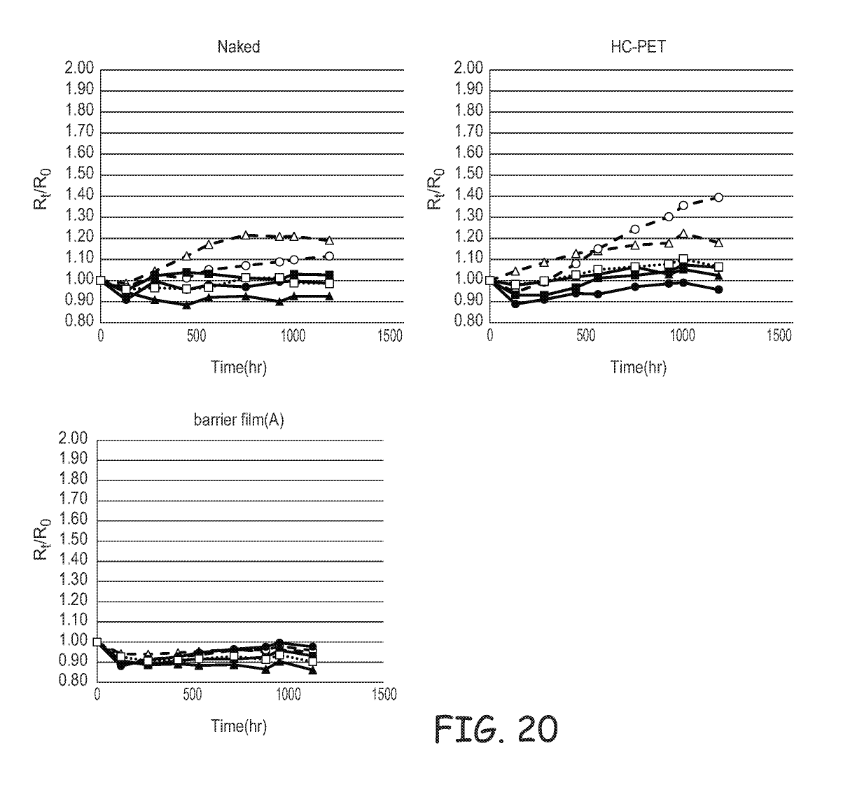

Samples were prepared with a barrier film (A) and hard coated PET. For comparison, naked samples, which don't have any cover film, were also prepared. The stability results are plotted in FIG. 20. A barrier film (A) exhibited very excellent stability. Naked and HC-PET case exhibited slight resistance increase in black tape region and boundary region between black tape and no uncovered area.

### Example 12

### Overcoat Layers with Stabilization Compounds, Concentration Dependence

This example demonstrates the stabilization effect of OC-2R (roll-to-roll coated HG03 overcoating solution).

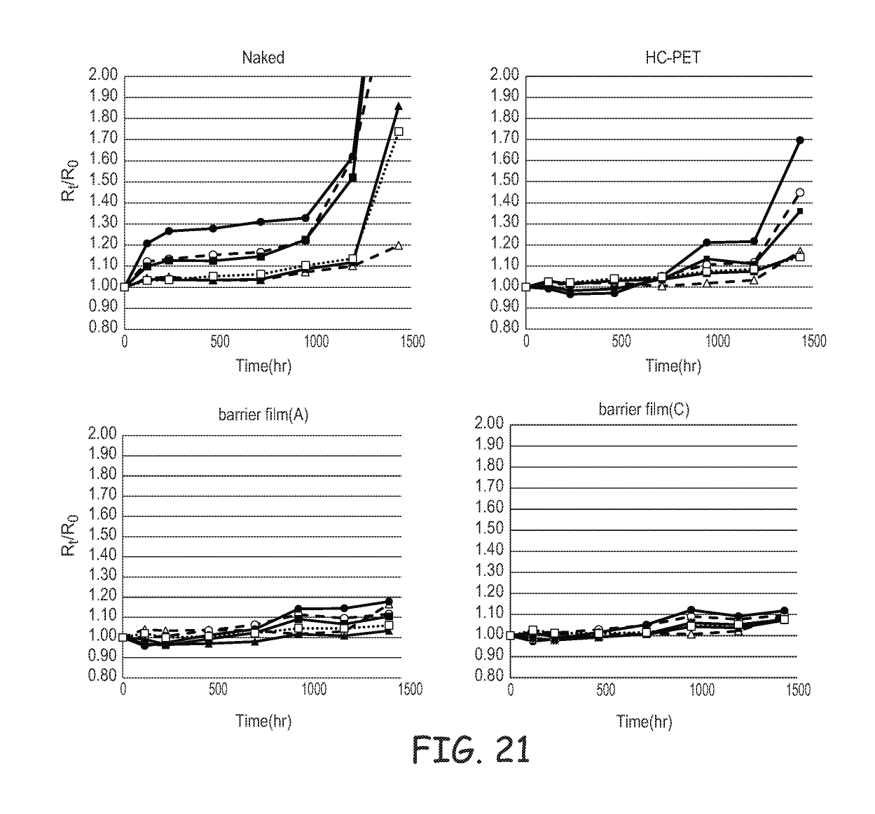

Samples were prepared with a barrier film (A), (C) and a HC-PET. WVP of barrier film (C) is inferior to that of barrier film (A), 0.06 g/(m²·day). For comparison, naked samples, which don't have any cover film, were also prepared. The stability results are plotted in FIG. 21. Both barrier film (A) and (C) exhibited very excellent stability. HC-PET exhibited good stability until about 750 hr but exhibited gradual resistance increase after that. Naked case exhibited resistance increase, then became stable until 1000 hr but exhibited steep resistance increase after that.

### Third set of Experiments

In a third set of experiments, films were fixed to a glass plate in the stack that the conductive side exposed to the air, then they were put in the chamber which was set at 150 degrees Celsius for 0.5 hr. Sheet resistance measurements with a contactless resistance meter were performed after the heat treatment. The increase of resistance was calculated by dividing the resistance after the heat treatment by the one before the heat treatment, outcome was gotten in the style of (100+ΔR) %. Stability was compared by ΔR %.

### Example 13

### Higher Temperature Testing

This example demonstrates the stabilization effect of over coating materials after heat treatment.

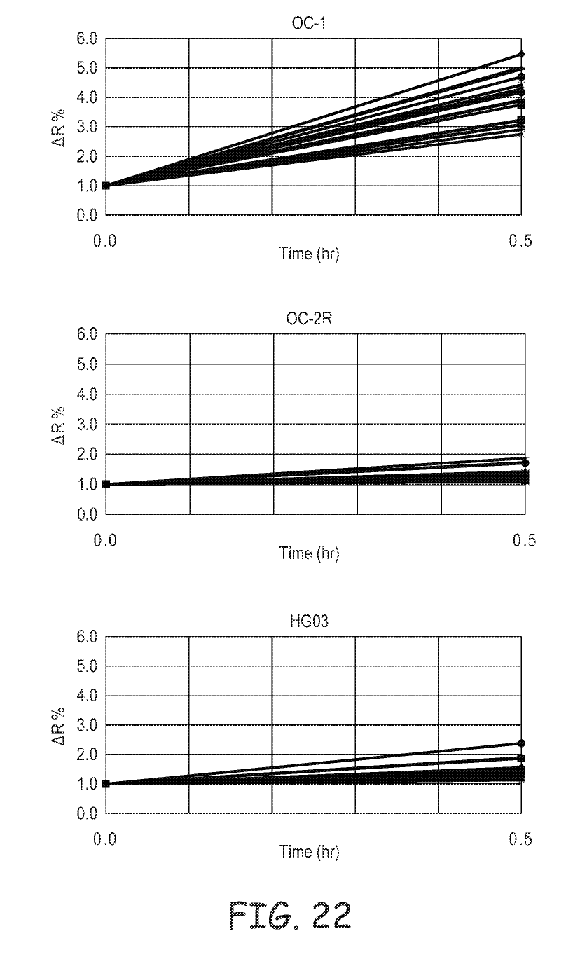

Three sets of samples with different coating layers were tested. One set was made with OC-1 containing 2.67 wt % of ST-1 in total solids, another set with HG03 (lab-coated), and the final set, labeled OC-2R, with roll-to-roll application of the HG03 composition. The stability results are plotted in FIG. 22. OC-1 exhibited significant resistance increase after heat treatment. On the other hand, samples HG03 and OC-2R exhibited resistance stability, roll-to-roll sample OC-2R was slightly better than lab-coated HG03.

The embodiments above are intended to be illustrative and not limiting. Additional embodiments are within the claims. In addition, although the present invention has been described with reference to particular embodiments, those skilled in the art will recognize that changes can be made in form and detail without departing from the spirit and scope of the invention. Any incorporation by reference of documents above is limited such that no subject matter is incorporated that is contrary to the explicit disclosure herein.

What is claimed is:

1. A transparent electrically conductive film comprising a polymer substrate, a sparse metal conductive layer, and a coating layer comprising a curable polymer and from about 0.1 wt % to about 8 wt % of a mercaptotriazole, a mercaptotetrazole or a combination thereof and having an average thickness from about 10 nm to about 2 microns.

2. The transparent electrically conductive film of claim 1 the coating layer has a thickness from about 50 nm to about 1 micron.

3. The transparent electrically conductive film of claim 1 wherein the polymer substrate comprises a hard coated polyester film having a thickness from about 15 microns to about 200 microns.

4. The transparent electrically conductive film of claim 1 wherein the mercaptotriazole, mercaptotetrazole or a combination thereof comprises a dithiobistetrazole at a concentration from about 0.25 wt % to about 4 wt % in the coating layer.

5. The transparent electrically conductive film of claim 1 further comprising an optically clear adhesive with a polyester carrier film and a protective film wherein the optically clear adhesive is adhered on one surface to the coating layer and on another surface to the protective film.

6. A transparent electrically conductive film comprising a polymer substrate, a conductive layer with a sparse metal conductive layer, a coating layer contacting the conductive layer and comprising a polymer and a stabilization composition, and a multiple layer optically clear adhesive on the coating layer, the multiple layer optically clear adhesive comprising an adhesive layer and a polyester carrier film between two adhesive layers with an average thickness of the combined adhesive layers and carrier film from about 10 micron to about 300 microns.

7. The transparent electrically conductive film of claim 6 wherein the coating layer comprises a stabilization compound dispersed through the polymer.

8. The transparent electrically conductive film of claim 6 wherein the optically clear adhesive comprises an acrylate based adhesive and has an average thickness of the combined adhesive layers and carrier film from about 10 microns to about 200 microns.

9. The transparent electrically conductive film of claim 6 further comprising a transparent protective film on the optically clear adhesive surface opposite the coating.

10. The transparent electrically conductive film of claim 9 wherein the transparent protective film has a water vapor permeability of no more than about 0.15 g/(m²·day) and a total transmittance of visible light of at least about 88%.

11. The transparent electrically conductive film of claim 9 wherein the transparent conductive film comprises a PET film, a one sided hard coated PET film, a two sided hard coated PET film, a polycarbonate film, a cyclic olefin polymer film, a cyclic olefin copolymer film or a combination thereof.

12. The transparent electrically conductive film of claim 6 wherein the sparse metal conductive layer comprises a fused metal nanostructured network, a stabilization compound in the coating layer and a transparent protective film on the optically clear adhesive surface opposite the coating.

13. A transparent electrically conductive film comprising a polymer substrate, a conductive layer with a nanostructured metal structure and a coating layer contacting the conductive layer and comprising a polymer and a stabilization composition, the coating layer having a concentration of light stabilization composition from about 0.1 wt % to about 8 wt %, wherein the sheet resistance of the transparent conductive film increases by no more than about 80% after covering with a black tape and spending 1000 hours in a chamber set at 38° C. at a relative humidity of 50%, a black standard temperature of 60° C. and irradiated with a Xenon lamp through a daylight filter at an intensity of 60 W/m² over the wavelength range from 300 nm to 400 nm.

14. The transparent electrically conductive film of claim 13 wherein the coating layer has a thickness from about 25 nm to about 2 microns.

15. The transparent electrically conductive film of claim 13 wherein the stabilization composition is a mercaptotriazole, a mercaptotetrazole, a blend of a hindered phenol antioxidant and a hindered amine light stabilization agent, a perfluoroalkylthiol compound, a heterocyclic compound with double 6-memebered rings containing two or more nitrogen atoms or derivatives thereof, or a combination thereof.

16. The transparent electrically conductive film of claim 13 wherein the sparse metal conductive layer comprises a fused metal nanostructured network.

17. The transparent electrically conductive film of claim 13 further comprising an optically clear adhesive with a polyester carrier film between two adhesive layers on the coating and a transparent protective layer on the optically clear adhesive surface opposite the coating, wherein the sheet resistance of the transparent conductive film increases by no more than about 40% after 1000 hours in a chamber set at 38° C. at a relative humidity of 50%, a black standard temperature of 60° C. and irradiated with a Xenon lamp through a daylight filter at an intensity of 60 W/m² over the wavelength range from 300 nm to 400 nm.

18. The transparent electrically conductive film of claim 17 wherein the sheet resistance of the transparent conductive film increases by no more than about 80% after 2000 hours in a chamber set at 38° C. at a relative humidity of 50%, a black standard temperature of 60° C. and irradiated with a xenon lamp through a daylight filter at an intensity of 60 W/m² over the wavelength range from 300 nm to 400 nm.

19. A transparent electrically conductive film comprising a polymer substrate, a sparse metal conductive layer, and a coating layer comprising a hindered phenol antioxidant and a hindered amine light stabilization agent.

20. The transparent electrically conductive film of claim 19 wherein the hindered amine light stabilization agent comprises derivatives of 2,2,6,6-tertamethylpiperidine ((CH₂)₅NH heterocycle) and the hindered phenol antioxidant comprises derivatives of 2,6-di-tert-butylphenol.

21. The transparent electrically conductive film of claim 19 wherein the coating layer has an average thickness from about 10 nm to about 2 microns and wherein the coating layer comprises from about 0.1 wt % to about 8 wt % each of hindered phenol antioxidant and of hindered amine light stabilizer.

22. The transparent electrically conductive film of claim 19 further comprising an optically clear adhesive with a polyester carrier film between two adhesive layers on the coating and a transparent protective layer on the optically clear adhesive surface opposite the coating, wherein the sheet resistance of the transparent conductive film increases by no more than about 80% after 1000 hours in a chamber set at 38° C. at a relative humidity of 50%, a black standard temperature of 60° C. and irradiated with a Xenon lamp through a daylight filter at an intensity of 60 W/m² over the wavelength range from 300 nm to 400 nm.

23. A transparent electrically conductive film comprising a sparse metal conductive layer with nanostructured metal structure, a polymer substrate and a coating layer, with at least one layer comprising a stabilization composition, wherein the stabilization composition comprises a perfluoroalkylthiol compound, phthalazine or derivatives thereof, a photoacid generator, a polysulfide, or combinations thereof.

24. The transparent electrically conductive film of claim 23 wherein the coating layer has an average thickness from about 10 nm to about 2 microns and wherein the coating layer comprises from about 0.1 wt % to about 8 wt % of stabilization composition.

25. The transparent electrically conductive film of claim 23 further comprising an optically clear adhesive with a polyester carrier film between two adhesive layers on the coating and a transparent protective layer on the optically clear adhesive surface opposite the coating, wherein the sheet resistance of the transparent conductive film increases by no more than about 80% after 1000 hours in a chamber set at 38° C. at a relative humidity of 50%, a black standard temperature of 60° C. and irradiated with a Xenon lamp through a daylight filter at an intensity of 60 W/m² over the wavelength range from 300 nm to 400 nm.
